(19) United States
(12) Patent Application Publication
(10) Pub. No.: US 2026/0356725 A1
(43) Pub. Date: Nov. 12, 2026

(54) DISTRIBUTION SHIFTING CONTROL METHODOLOGIES FOR CONVERTING GLASS TUBE TO GLASS ARTICLES

(71) Applicant: CORNING INCORPORATED, CORNING, NY (US)

(72) Inventors: Christelle Ruby Barnard, Painted Post, NY (US); Eric Michael Gross, Pittsburgh, PA (US); Joseph Michael Matusick, Corning, NY (US); Kevin Patrick McNelis, Elmira, NY (US); Connor Thomas O'Malley, Painted Post, NY (US)

(21) Appl. No.: 19/490,806

(22) PCT Filed: May 22, 2024
(86) PCT No.: PCT/US2024/030491

§ 371 Date: Dec. 5, 2025

Related U.S. Application Data
(60) Provisional application No. 63/471,872, filed on Jun. 8, 2023.

(51) Int. Cl. C03B 23/09; C03B 23/045; G05B 17/02

(52) U.S. Cl. CPC C03B 23/095; C03B 23/045; G05B 17/02

(57) ABSTRACT

Methods for controlling a converter includes operating the converter to produce glass articles from glass tubes, where the converter includes a plurality of processing stations and operating the converter includes translating the glass tubes through the processing stations in succession. The methods include measuring an attribute of the glass articles during or after conversion, developing an attribute distribution from measured values of the attribute, and shifting the attribute distribution within a specification range for the attribute. Shifting the attribute distribution within the specification range increases a yield of the glass articles. A system for converting glass articles from glass tubes includes a converter, a measuring device, a control device, and a control system operable to execute portions of or all of methods disclosed herein for controlling the converter.

### CROSS-REFERENCE TO RELATED APPLICATIONS

This application claims the benefit of priority under 35 U.S.C. § 119 of U.S. Provisional Application Ser. No. 63/471,872 filed on Jun. 8, 2023, the content of which is relied upon and incorporated herein by reference in its entirety.

### FIELD

The present specification generally relates to systems and methods for producing glass articles from glass tubes, in particular, systems and methods for controlling a glass tube converting process for converting glass tubes to glass vials.

### TECHNICAL BACKGROUND

Historically, glass has been used as the preferred material for packaging pharmaceuticals because of its hermeticity, optical clarity, and excellent chemical durability relative to other materials. Specifically, the glass used in pharmaceutical packaging must have adequate chemical durability to prevent affecting the stability of the pharmaceutical compounds and/or formulations contained therein. Glasses having suitable chemical durability include, but are not limited to, those glass compositions within the ASTM standard ‘Type IA’ and ‘Type IB’ glass compositions, which have a proven history of chemical durability.

Glass tubing may be converted into glass articles, such as various glass containers for use in pharmaceutical applications including, without limitation, vials, syringes, ampoules, cartridges, and other glass articles. The glass tubing may be converted, for example, in “converting machines.” Converting machines have been used for over 75 years, and are currently made by various commercial and internal equipment suppliers. These converting machines typically reform long lengths of glass tube into a plurality of glass articles using steps that include flame working, rotating and stationary tool forming, thermal separation, or score and shock cutoff steps, among other steps. Various burners and forming tools are often used to shape one or more of the glass articles from the glass tube and separate each of the glass articles from the glass tube.

### SUMMARY

During conversion of glass tubes to glass articles using a converting machine (i.e., converter), heating elements, such as burners, heat the glass of the glass tube to a temperature at which the viscosity of the glass allows the glass to be formed into one or more features of the glass article. Forming stations include forming tools, such as pin and wheel assemblies, to make contact with the heated glass tube and form the internal and external dimensions of features of the finished glass articles. The converter can have hundreds process settings and inputs that can influence the dimensional yields and defect rates achieved by the converting machine.

Current methods for producing glass articles from glass tubes using converting machines have long relied on manual observation of the behavior of one or more attributes of the glass article followed by manual adjustment or pseudo-manual adjustment, for cases in which the actuators are dial adjusted stages or servos driven by a programmable logic controller, of one or more process variables. The converting process is normally slow drifting but can be punctuated occasionally by sudden shifts in one or more attributes of the glass articles. Thus, the maximum achievable yield from the converting machine can vary over time and may depend on the evolving shape over time of the distribution of one or more attributes of the glass article. Further, attributes exhibiting non-normal distributions (e.g., asymmetric distributions, multi-modal distributions, or the like) in the measured values of the attribute may be difficult to control to maximize yield through human operator or automated feedback control methodologies.

Accordingly, a need exists for systems and methods for controlling one or more operations of a converter for converting glass tubes into glass articles, such as pharmaceutical packaging, to increase yield of the glass articles from the glass tube.

A first aspect of the present disclosure may be directed to a method for controlling a converter for producing glass articles from glass tubes. The method may comprise operating the converter to produce the glass articles from the glass tubes, where the converter may comprise a plurality of processing stations and operating the converter may comprise translating the glass tubes through each of the plurality of processing stations in succession. The methods may comprise measuring an attribute of the glass articles during or after conversion where the attribute is subject to gradual change over time, sudden change, or both; developing an attribute distribution from measured values of the attribute; and shifting the attribute distribution within a specification range for the attribute, wherein shifting the attribute distribution may increase a yield of the glass articles.

A second aspect of the present disclosure may include the first aspect, wherein shifting the attribute distribution may comprise adjusting at least one process setting.

A third aspect of the present disclosure may the second aspect, wherein adjusting the at least one process setting may comprise determining an updated setpoint of the at least one process setting and adjusting the at least one process setting to the updated setpoint.

A fourth aspect of the present disclosure may include the third aspect, wherein determining the updated setpoint of the at least one process setting may comprise determining a shift in the attribute distribution within the specification range that increases the yield of the glass articles, and calculating the updated setpoint of the at least one process setting from a magnitude and a direction of the shift in the attribute distribution and a control relationship between the at least one process setting and the attribute.

A fifth aspect of the present disclosure may include the fourth aspect, wherein determining the shift in the attribute distribution within the specification range that increases the yield of the glass articles may comprise conducting a plurality of simulations, wherein in each of the plurality of simulations, the attribute distribution may be shifted by a different magnitude, direction, or both; determining a best simulation from the plurality of simulations, wherein the best simulation may produces a greatest yield of the glass articles; and setting the magnitude and the direction of the shift in the attribute distribution equal to the magnitude and the direction corresponding to the best simulation.

A sixth aspect of the present disclosure may include the fifth aspect, wherein two or more of the plurality of simulations may result in 100% yield of the glass articles, and the best simulation may comprise a simulation in which a smallest absolute value of a difference between the measured values of the attribute distribution and an upper limit or a lower limit of the specification range is greatest and the yield of the glass articles is 100%.

A seventh aspect of the present disclosure may include either one of the fifth or sixth aspects, wherein two or more of the plurality of simulations may result in 100% yield of the glass articles, the attribute may be known to drift in a direction towards an upper limit or a lower limit of the specification range, and the best simulation may comprise a simulation that results in 100% yield of the glass articles and provides a greatest absolute value of a difference between either the upper limit or the lower limit and a closest measured value to the upper limit or the lower limit, respectively.

An eighth aspect of the present disclosure may include any one of the fifth through seventh aspects, wherein determining the shift in the attribute distribution within the specification range may comprise determining if a benefit of shifting the attribute distribution within the specification range is greater than a cost of shifting the attribute distribution; when the benefit of shifting the attribute distribution is greater than the cost, adjusting the at least one process setting to shift the attribute distribution with the specification range; and when the benefit of shifting the attribute distribution is less than the cost, maintaining the at least one process setting.

A ninth aspect of the present disclosure may include any one of the fourth through eighth aspects, wherein determining the shift in the attribute distribution within the specification range that increases the yield of the glass articles may comprise analyzing the attribute distribution to determine a property, a relationship, or both that is characteristic of the attribute distribution and calculating the shift in the attribution distribution within the specification range that increases the yield of the glass articles from the property, the relationship, or both that is characteristic of the attribute distribution.

A tenth aspect of the present disclosure may include any one of the first through second aspects, 10. The method of claim 9, wherein analysing the attribute distribution to determine a property, a relationship, or both that is characteristic of the attribute distribution comprises applying first principles, statistical methods, or both to the attribute distribution.

An eleventh aspect of the present disclosure may include any one of the fourth through tenth aspects, further comprising: after adjusting the at least one process setting, measuring the attribute of the glass articles; developing a post-shift attribute distribution based on the measured attributes of the glass articles after adjusting the at least one process setting; comparing the post-shift attribute distribution to a predicted attribute distribution, where the predicted attribute distribution may be calculated by applying the shift to the attribute distribution produced prior to adjusting the at least one process setting; and further adjusting the at least one process setting based on the comparison of the post-shift attribute distribution and the predicted attribute distribution.

A twelfth aspect of the present disclosure may include the eleventh aspect, wherein comparing the post-shift attribute distribution to the predicted attribute distribution may comprise calculating an error between a property of the post-shift attribute distribution and the same property of the predicted attribute distribution, and shifting the post-shift attribute distribution may be based on the error.

A thirteenth aspect of the present disclosure may include either one of the eleventh of twelfth aspects, comprising developing an updated control relationship between the at least one process setting and the attribute.

A fourteenth aspect of the present disclosure may include the thirteenth aspect, wherein developing the updated control relationship may comprise conducting a design of experiments process or a calibration.

A fifteenth aspect of the present disclosure may include any one of the second through fourteenth aspects, wherein adjusting the at least one process setting may comprise determining one or more causes of deviations of the attribute distribution outside of the specification range, and modifying an adjustment to the setpoint of the at least one process setting depending on the one or more causes of the deviation of the attribute distribution.

A sixteenth aspect of the present disclosure may include any one of the first through fifteenth aspects, wherein the converter may comprise a plurality of holders and operating the converter may comprise securing a glass tube in two or more of the plurality of holders and translating each of the plurality of holders through the plurality of processing stations in succession, wherein the method may further comprise developing an attribute distribution for each of the plurality of holders from the measured values of the attribute and shifting the attribute distribution for each of the plurality of holders within a specification range for the attribute, wherein shifting the attribute distribution for each of the plurality of holders may increase a yield of the glass articles.

A seventeenth aspect of the present disclosure may include any one of the first through sixteenth aspects, wherein shifting the attribute distribution within the specification range may comprise determining whether a shift in the attribute distribution within a specification range for the attribute increases a yield of the glass articles and, when the shift in the attribute distribution increases the yield of the glass articles, shifting the attribute distribution within the specification range for the attribute.

An eighteenth aspect of the present disclosure may include any one of the first through seventeenth aspects, wherein, when a shift in the attribute distribution does not increase in the yield, the method may comprise maintaining the at least one process setting at a present setpoint.

A nineteenth aspect of the present disclosure may include any one of the first through eighteenth aspects, wherein the glass article may be a glass vial and the attribute may be selected from a vial height, and inner diameter of a flange, an outer diameter of the flange, a thickness of the flange, a height of the flange, a radius of a shoulder, a height of the shoulder, an outer diameter of a neck, or combinations thereof.

A twentieth aspect of the present disclosure may include the nineteenth aspect, wherein the attribute may be a vial height of the glass vial.

A twenty-first aspect of the present disclosure may include the twentieth aspect, wherein the at least one process setting may be a stopper height in a tube drop station of the converter.

A twenty-second aspect of the present disclosure may include the nineteenth aspect, wherein the glass article may be a glass vial and the attribute may be an inner diameter of a flange of the glass vial.

A twenty-third aspect of the present disclosure may include any one of the first through twenty-second aspects, wherein the developing the attribute distribution may comprise measuring the attribute over a lookback window.

A twenty-fourth aspect of the present disclosure may include the twenty-third aspect, wherein the lookback window may comprise a statistically relevant number of glass articles produced.

A twenty-fifth aspect of the present disclosure may include any one of the first through twenty-fourth aspects, further comprising measuring the attribute of the glass article after forming one or more features of the glass article at the working end of the glass tube.

A twenty-sixth aspect of the present disclosure may include any one of the first through twenty-fifth aspects, wherein operating the converter may comprise forming one or more features of the glass article at a working end of the glass tube and, after the forming, separating the glass article from the working end of the glass tube; and measuring the attribute after the forming the one or more features of the glass article and the separating the glass article from the working end of the glass tube.

A twenty-seventh aspect of the present disclosure may include any one of the first through twenty-sixth aspects, comprising measuring the attribute of the glass article after conversion to produce the glass article.

A twenty-ninth aspect of the present disclosure may include the twenty-seventh aspect, further comprising annealing the glass article after operating the converter to produce the glass article from the glass tubes, wherein measuring the attribute may be conducted after the annealing the glass article.

A twenty-ninth aspect of the present disclosure may include any one of the first through twenty-eighth aspects, wherein the attribute distribution may deviate from a normal distribution or may be a non-symmetric distribution.

A thirtieth aspect of the present disclosure may be directed to a system for producing glass articles from a glass tube, the system may comprise a converter comprising a plurality of processing stations and at least one control device, wherein: the converter may be operable to translate the glass tube through each of the processing stations in sequence; translating the glass tube through each of the processing stations in sequence may form one or more features of the glass articles and may separate the glass articles from a working end of the glass tube; the glass articles may comprise an attribute; and the at least one control device may be operable to change a process setting that effects the attribute of the glass articles. The system may comprise a measurement device positioned to measure the attribute of the glass articles during or after converting and a control system communicatively coupled to the converter and to the measurement device. The control system may comprise a processor, a memory module communicatively coupled to the processor, and machine readable and executable instructions stored on the memory module. The machine readable and executable instructions, when executed by the processor, may cause the control system to automatically measure the attribute of the glass articles with the measurement device; develop an attribute distribution based on measured values of the attribute of the glass articles; determine whether a shift in the attribute distribution within a specification range for the attribute increases a yield of the glass articles; and when the shift in the attribute distribution increases the yield of the glass articles, shift the attribute distribution within the specification range for the attribute.

A thirty-first aspect of the present disclosure may include the thirtieth aspect, wherein the measurement device may be positioned in a processing station of the converter, coupled to one or more holders of the converter, positioned downstream of the converter, or combinations thereof.

A thirty-second aspect of the present disclosure may include either one of the thirtieth or thirty-first aspects, wherein the system may comprise an annealing process for annealing the glass articles, and the measurement device may be positioned downstream of the annealing process.

A thirty-third aspect of the present disclosure may include any one of the thirtieth through thirty-second aspects, wherein the plurality of processing stations may comprise a tube length drop station comprising a mechanical stopper and a stopper actuator, the stopper actuator may be configured to change a position of the mechanical stopper axially relative to a working end of the glass tubes, and the attribute may be an overall height of the glass article.

A thirty-fourth aspect of the present disclosure may include any one of the thirtieth through thirty-third aspects, wherein the glass articles may be glass vials; the plurality of processing stations may comprise at least one flange forming station comprising one or more forming tools and one or more forming tool actuators operable to change a position of one or more forming tools; and the attribute may be a flange inner diameter of the glass vials.

A thirty-fifth aspect of the present disclosure may include any one of the thirtieth through thirty-fourth aspects, wherein the machine readable and executable instructions, when executed by the processor, may cause the control system to automatically adjust at least one process setting of the converter to shift the attribute distribution within the specification range for the attribute.

A thirty-sixth aspect of the present disclosure may include the thirty-fifth aspect, wherein the machine readable and executable instructions, when executed by the processor, may cause the control system to automatically determine an updated setpoint of the at least one process setting when the shift in the attribute distribution increases the yield of the glass articles and adjust the at least one process setting to the updated setpoint.

A thirty-seventh aspect of the present disclosure may include the thirty-sixth aspect, wherein the machine readable and executable instructions, when executed by the processor, may cause the control system to automatically calculate the updated setpoint of the at least one process setting from a magnitude and a direction of the shift in the attribute distribution and a control relationship between the at least one process setting and the attribute.

A thirty-eighth aspect of the present disclosure may include the thirty-seventh aspect, wherein the machine readable and executable instructions, when executed by the processor, may cause the control system to automatically conduct a plurality of simulations, wherein in each of the plurality of simulations, the attribute distribution may be shifted by a different magnitude, direction, or both; determine a best simulation from the plurality of simulations, wherein the best simulation may produce a greatest yield of the glass articles; and set the magnitude and the direction of the shift in the attribute distribution equal to the magnitude and the direction corresponding to the best simulation.

It is to be understood that the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a front view of an embodiment of system comprising a converter for producing glass articles from glass tubes, according to one or more embodiments shown and described herein;

FIG. 2 schematically depicts a top view of a main turret and a secondary turret of the converter of FIG. 1, according to one or more embodiments shown and described herein;

FIG. 3 schematically depicts a heating station of the converter of FIGS. 1 and 2, according to one or more embodiments shown and described herein;

FIG. 4 schematically depicts one embodiment of a forming station of the converter of FIG. 1, according to one or more embodiments shown and described herein;

FIG. 5 schematically depicts another embodiment of a forming station of the converter of FIG. 1, according to one or more embodiments shown and described herein;

FIG. 6 schematically depicts a tube length drop station of the converter of FIG. 1, according to one or more embodiments shown and described herein;

FIG. 7 schematically depicts a separating station of the converter of FIG. 1, according to one or more embodiments shown and described herein;

a

FIG. 8 schematically depicts a measuring station of the converter of FIG. 1, according to one or more embodiments shown and described herein;

FIG. 9 schematically depicts a perspective view of a section of a glass tube prior to conversion in the converter of FIG. 1, according to one or more embodiments shown and described herein;

FIG. 10 schematically depicts a cross-sectional view of a glass article comprising a vial, according to one or more embodiments shown and described herein;

FIG. 11 schematically depicts another embodiment of a system comprising a converter for converting producing glass articles from glass tubes and a distributed computing environment communicatively coupled to the converter, according to one or more embodiments shown and described herein;

FIG. 12 is a flow chart of a method for controlling operation of the converter of FIGS. 1 and 11, according to one or more embodiments shown and described herein;

FIG. 13 graphically depicts a relative vial height of glass vials (y-axis) as a function of time (x-axis) for glass vials produced, according to one or more embodiments shown and described herein;

FIG. 14 graphically depicts a relative flange inner diameter (y-axis) as a function of time (x-axis) for glass vials produced by the system of FIG. 1, according to one or more embodiments shown and described herein;

FIG. 15 graphically depicts a box plot of the relative flange inner diameter (y-axis) as a function of holder number (x-axis) for the glass vials of FIG. 14, according to one or more embodiments shown and described herein;

FIG. 16 graphically depicts a yield (y-axis) with respect to flange inner diameter as a function of holder number (x-axis) for the glass vials of FIG. 14, according to one or more embodiments shown and described herein;

FIG. 17 graphically depicts actual historic yield and predicted yield with respect to flange inner diameter (y-axis) as a function of time (x-axis) for the glass vials of FIG. 14, according to one or more embodiments shown and described herein;

FIG. 18 graphically depicts a history of recommended changes in the process setting (y-axis) based on shifting the attribute distribution as a function of time (x-axis) for the glass vials of FIG. 14, according to one or more embodiments shown and described herein; and

FIG. 19 graphically depicts yield of glass vials with respect to flange inner diameter for a series of production trials for producing glass vials, according to one or more embodiments shown and described herein.

### DETAILED DESCRIPTION

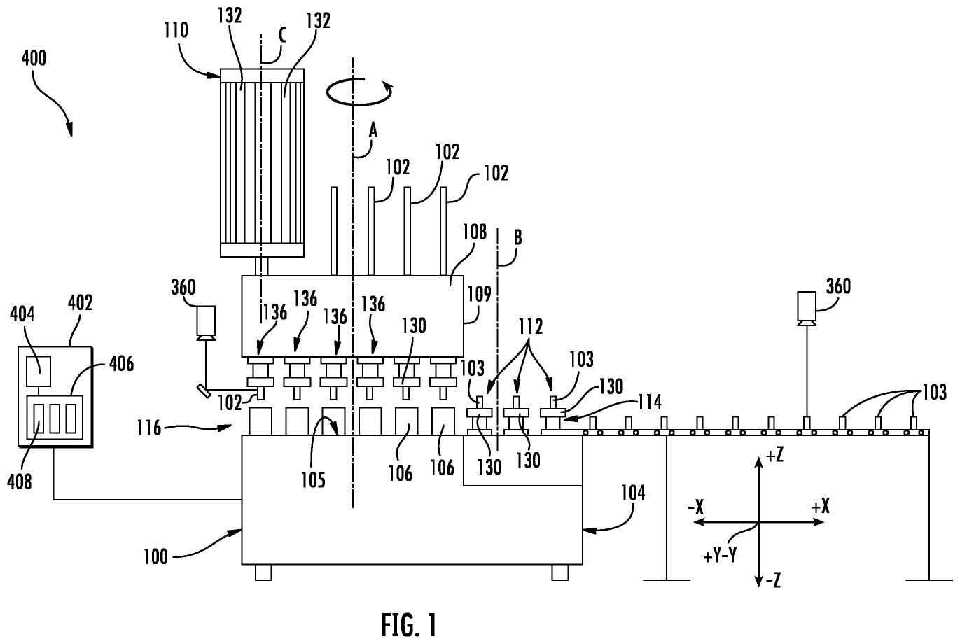

Reference will now be made in detail to embodiments of systems and methods of the present disclosure for controlling operation of a glass tube converting process for producing glass articles, examples of which are illustrated in the accompanying drawings. Whenever possible, the same reference numerals will be used throughout the drawings to refer to the same or like parts. Referring now to FIG. 1, a system 400 disclosed herein for producing glass articles 103 from glass tubes 102 comprises a converter 100, a measurement device 360 positioned to measure an attribute of the glass articles 103 during or after converting, and a control system 402 communicatively coupled to the converter 100 and to the measurement device 360. The converter 100 may include a plurality of processing stations 106 and at least one control device, and the converter 100 may be operable to translate the glass tubes 102 through each of the processing stations 106 in succession. Translating the glass tubes through each of the processing stations 106 in succession forms one or more features of the glass articles 103 and separates the glass articles 103 from a working end of the glass tubes 102. The glass articles 103 comprise at least one attribute. The at least one control device may be operable to change a process setting of the converter 100 that effects the attribute of the glass articles 103. The control system 402 may comprise a processor, a memory module communicatively coupled to the processor, and machine readable and executable instructions stored on the memory module. The machine readable and executable instructions, when executed by the processor, may cause the control system to automatically measure the attribute of the glass articles 103 with the measurement device 360, develop an attribute distribution based on measured values of the attribute of the glass articles 103, determine whether a shift in the attribute distribution within a specification range for the attribute increases a yield of the glass articles 103, and when the shift in the attribute distribution increases the yield of the glass articles 103, shift the attribute distribution within the specification range for the attribute.

Methods disclosed herein for controlling the converter 100 for producing glass articles 103 from glass tubes 102 may include operating the converter 100 to produce the glass articles 103 from the glass tubes 102, where the converter 100 comprises a plurality of processing stations 106 and operating the converter 100 comprises translating the glass tubes 102 through each of the plurality of processing stations 106 in succession. The methods may further include measuring an attribute of the glass articles 103 during or after conversion where the attribute is subject to gradual change over time, sudden change (e.g., step change), or both. The methods may further include developing an attribute distribution from measured values of the attribute, and shifting the attribute distribution within a specification range for the attribute, wherein shifting the attribute distribution may increase a yield of the glass articles 103. The systems and method herein may enable control of attributes of the glass articles having asymmetric, multi-modal, or other non-normal attribute distributions.

Directional terms as used herein—for example up, down, right, left, front, back, top, bottom—are made only with reference to the figures as drawn and the coordinate axis provided therewith and are not intended to imply absolute orientation.

Unless otherwise expressly stated, it is in no way intended that any method set forth herein be construed as requiring that its steps be performed in a specific order, nor that specific orientations be required with any apparatus. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the “working end” of the glass tube is the end of the glass tube oriented towards the processing stations of the main turret of the converter relative to the holder, and the “non-working end” of the glass tube is the end of the glass tube oriented away from the processing stations of the main turret.

As used herein, a “dwell time” of the converter refers to the duration of time that the glass tube spends in a particular processing station before passing to the next subsequent processing station.

As used herein, the term “active time” refers to a duration of time that the glass tube is maintained in engagement with at least one heating element or at least one forming tool while in a particular processing station.

As used herein, the term “index time,” when used in relation to an index converter, refers to a duration of time that it takes to index the glass tube from one processing station to the next processing station. The “dwell time,” “active time,” and “index time” are all measured in units of time.

When used in relation to a heating station, “engagement” of a burner with the glass tube refers to placing the burner in a position in which the flame from the burner extends towards the glass tube or contacts the glass tube to heat the glass tube. Conversely, when the burner is out of engagement with the glass tube, the burner is placed in a position in which the flame from the burner is directed away from the glass tube or moved far enough away from the glass tube so that the flame does not contact or directly heat the glass tube.

When used in relation to forming tools in a forming station, the term “engagement” refers to the forming tools contacting the glass tube. When a forming tool is out of engagement with the glass tube, the forming tool does not contact the glass tube.

As used herein, the term “part rate” refers to the production rate or throughput rate of the converter in units of number of glass articles per unit time.

As used herein, the term “circumference” of the glass tube refers to a collection of points of the glass tube at constant radius r from the center axis D of the glass tube at a particular Z position (i.e., position on the +/−Z axis of the figures) through 360 degrees. A circumference of the glass tube may coincide with an outer surface of the glass tube at a particular Z position or an inner surface of the glass tube at a specific Z position, for example.

As used herein, the term “run” refers to the normal steady state operation of the converter. Thus, as used herein, a “run setting” refers to a setting of the converter for normal steady state operation of the converter.

As used herein, the terms “upstream” and “downstream” refer to the positioning of processing stations of the converter relative to each other. A first processing station is considered “downstream” of a second processing station if the glass tube encounters the second processing station before encountering the first processing station. Likewise, the first processing station is considered “upstream” of the second processing station if the glass tube encounters the first processing station before encountering the second processing station.

Glass tubing may be converted into glass articles, in particular glass articles for use in pharmaceutical applications, which may include, without limitation, vials, vacutainers, syringes, ampoules, cartridges, jars, and other glass articles. The glass tubing may be converted into these glass articles using a converter (i.e., a converting machine) comprising a plurality of processing stations. The processing stations can include heating stations, forming stations, tube-drop stations, thermal separating stations, and piercing stations, among other types of processing stations. The converting machines typically reform long glass tube lengths into a plurality of glass articles using steps that include, but are not limited to, heating, rotating and stationary tool forming, separation (e.g., thermal separation or score and shock cut-off steps), piercing, cooling, measuring, or other processing steps. Thus, glass articles produced through a converting process conducted on a converting machine are subjected to a series of heating elements and forming tools to shape the glass tube to specific shapes and dimensions and separate a formed glass article from the working end of the glass tube.

Referring now to FIG. 1, one embodiment of a system 400 for converting glass tubes 102 to glass articles 103 is schematically depicted. The system 400 may comprise a converter 100 for converting glass tubes 102 in the glass articles 103 and a control system 402 communicatively coupled to the converter 100. The converter 100 may include a base 104 having a plurality of processing stations 106 and a main turret 108 positioned above the base 104 and rotatable relative to the base 104 about the central axis A. The converter 100 may further include a glass tube loading turret 110 positioned above the main turret 108 for feeding glass tubes 102 to the main turret 108. The converter 100 may also include a plurality of secondary processing stations 112 on the base 104 and a secondary turret 114, which may be rotatable relative to the base 104.

As schematically depicted in FIG. 1, the base 104 of the converter 100 may be stationary and the processing stations 106 may be coupled to the base 104. The plurality of processing stations 106 may be spaced apart from one another and arranged in a main circuit 116. In embodiments, the main circuit 116 may be circular so that the main turret 108 may index or continuously move a glass tube 102 through the plurality of processing stations 106 by rotation of the main turret 108 about the central axis A. Alternatively, in other embodiments, the main circuit 116 may be linear arrangement of the processing stations 106. Although described herein in reference to a circular-shaped layout of processing stations 106, it is understood that the subject matter disclosed herein may apply equally well to converters having other arrangements of the processing stations 106, such as linear, curvilinear, or irregular-shaped arrangements of processing stations 106.

The type and/or shape of the glass articles to be made from the glass tube 102 may influence the total number of processing stations 106 of the converter 100. The number of processing stations 106 of the main turret 108 may be from 14 to 32 processing stations 106. Although the converter 100 and converting process are described herein in the context of a converter 100 having sixteen processing stations 106 in the main circuit 116, it is understood that the converter 100 may have more or less than sixteen processing stations 106 in the main circuit 116. The processing stations 106 may include, by way of example and without limitation, one or more heating, forming, polishing, cooling, tube length drop, separating, piercing, measuring, feeding, discharge stations, other processing stations, or combinations of these for producing the glass articles from the glass tubes 102. The type and/or shape of the article to be made from the glass tube 102 may also influence the type of processing stations 106 and/or order of processing stations 106 of the converter 100.

The main turret 108 may be positioned above the base 104 and may be rotatably coupled to the base 104 so that the main turret 108 is rotatable about the central axis A relative to the base 104. A drive motor (not shown) may be utilized to rotate the main turret 108 relative to the base 104. The main turret 108 may include a plurality of holders 130 configured to removably secure each glass tube 102 to the main turret 108. The holders 130 may be clamps, chucks, or other holding devices, or combinations of holding devices. In embodiments, the holders 130 may be chucks. The holders 130 may orient each glass tube 102 so that the glass tube 102 is parallel to the central axis A of the main turret 108. Although the converter 100 is described in this specification in the context of a vertically oriented converter 100, it should be understood that the converter 100 may be oriented horizontally or at an angle such that the glass tube 102 is non-vertical during processing. Each holder 130 may be oriented to position the glass tube 102 in each of the successive processing stations 106 of the main circuit 116 as the main turret 108 translates the holder 130 and glass tube 102 through each of the processing stations 106 in succession.

In embodiments, the converter 100 may be operable to translate each of the plurality of holders 130 progressively through the plurality of processing stations 106. In embodiments, the converter 100 may index the holders 130 through each of the processing stations 106. Indexing may refer to the stepwise process of moving the glass tube 102 into a processing station 106, maintaining the glass tube 102 at a stationary position XYZ position in the processing station 106 for a dwell time, and then indexing the glass tube 102 to the next processing station 106. Alternatively, in embodiments, the converter 100 may be operable to translate the plurality of holders 130 continuously through the converting process. In embodiments, the processing stations 106 may translate with the glass tube 102 during the active time of the glass tube 102 in the processing station.

Each holder 130 may be individually rotatable relative to the main turret 108 to rotate the glass tube 102 about center axis D of the glass tube 102, which can be parallel to the central axis A of the main turret 108. Rotation of the holders 130 allows for rotation of the glass tube 102 about center axis D of the glass tube 102 relative to stationary burners, forming tools, cooling nozzles, or other features of the processing stations 106. The heating element or forming tools in the processing stations 106 may be maintained in a fixed position relative to the glass tube 102, and the rotation of the glass tube 102 about center axis D may enable exposure of the entire circumference of the glass tube 102 to the heating elements or forming tools.

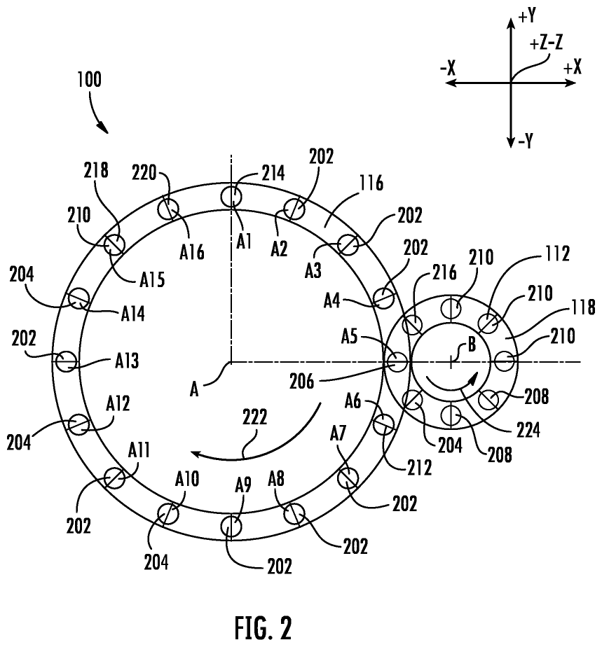

Referring to FIGS. 1 and 2, the converter 100 may include a plurality of secondary processing stations 112, which may also be spaced apart and arranged in a secondary circuit 118 (FIG. 2). The converter 100 may include a secondary turret 114 (FIG. 1) for indexing or continuously moving the glass articles, which have been separated from the glass tube 102, through the plurality of secondary processing stations 112. The secondary turret 114 may rotate about the axis B in a direction 224 that is opposite from the main turret 108. In embodiments, the secondary turret 114 may rotate in a direction that is the same as the main turret 108. The secondary turret 114 may also include a plurality of secondary holders 132 to hold the glass articles 103 and position the glass articles 103 to engage with each of the secondary processing stations 112 in succession. The secondary turret 114 may receive the glass articles 103 from a separating station 206 (FIG. 2) of the main turret 108, index or continuously move the articles 103 through the plurality of secondary processing stations 112 through rotation of the secondary turret 114, and discharge the finished articles from the converter 100. Although shown in a circular pattern, it is understood that the secondary processing stations 112 may be arranged in a linear, curvilinear, or irregular arrangement. The secondary processing stations 112 may be referred to as a bottom-forming machine. For glass articles 103 that are vials, the secondary processing stations 112 may be operable to form the bottoms of the vials.

Referring now to FIG. 2, as previously described, the plurality of processing stations 106 of the converter 100 may include one or more heating stations 202, forming stations 204, separating stations 206, cooling stations 210, piercing stations 212, tube loading stations 214, discharge stations 216, measuring stations 218, tube length drop stations 220, or other stations and/or combinations of these stations. FIG. 2 schematically depicts the arrangement of the processing stations 106 for a converter 100 having a main circuit 116 of sixteen processing stations 106 and a secondary circuit 118 of eight secondary processing stations 112.

The main circuit 116 of the converter schematically depicted in FIG. 2 may include one or more heating stations 202, a separating station 206, a piercing station 212, one or more forming stations 204, one or more cooling stations 210, a measuring station 218, a tube length drop station 220, and a tube loading station 214. Although FIG. 2 depicts the main circuit 116 as having a circular arrangement of the processing stations 106, as previously discussed, the main circuit 116 may have the processing stations 106 positioned in other non-circular-shaped arrangements, such as linear, curvilinear, irregular-shaped, or other arrangements. The processing stations 106 in the main circuit 116 may be operable to form one or more features of the glass article 103 at the working end of the glass tube 102 and separate the partially formed glass article 103 from the working end of the glass tube 102.

The secondary processing stations of the secondary circuit may include one or more heating stations 202, forming stations 204, polishing stations 208, cooling stations 210, discharge stations 216, or other stations or combinations of secondary processing stations 112. Although FIG. 2 depicts the secondary circuit as having a circular arrangement of the secondary processing stations 112, as previously discussed, the secondary circuit may have the secondary processing stations 112 positioned in other non-circular arrangements, such as linear, curvilinear, irregular-shaped, or other arrangements. In embodiments, the secondary processing stations 112 of the secondary circuit 118 may be used to form one or more features of the glass article 103, such as a vial, ampoule, cartridge, or syringe, for example, at an end of the glass article 103 opposite the end formed by the main turret 108. For example, in embodiments, the glass article 103 may be a vial, and the forming stations 204 of the secondary circuit 118 may form the bottom of the vial. Other features are also contemplated such as those features characteristic of ampoules, cartridges, syringes, and the like. The secondary circuit 118 may include one or more polishing stations 208 to finish the surface of the glass article. The secondary circuit 118 may further include a plurality of cooling stations 210 and the discharge station 216, at which station the finished glass article 103 may be discharged from the converter 100. In embodiments, the secondary circuit 118 may include a measuring station 218.

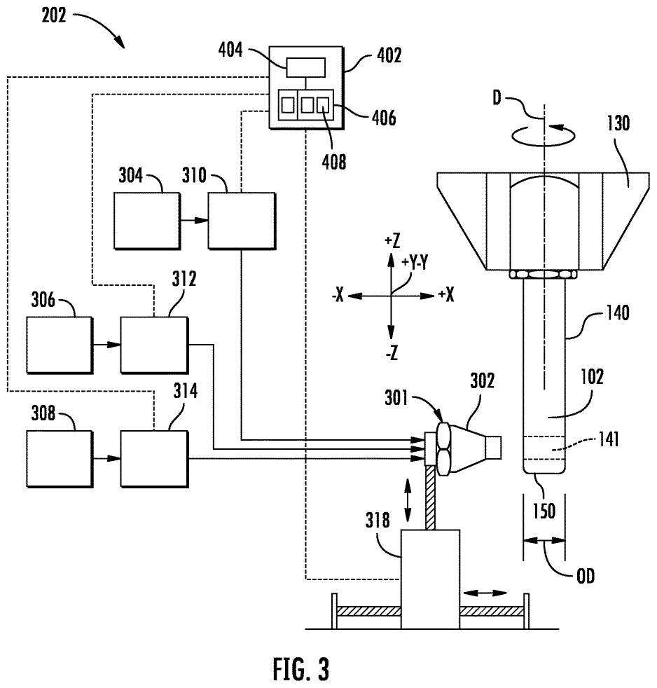

Referring again to FIG. 2, with respect to the direction of translation 222 of the main turret 108, the heating stations 202 may be positioned before each of the forming stations 204 and before the separating stations 206 to preheat target regions of the glass tube 102 to a viscosity at which the glass becomes deformable and may effectively be shaped or stretched and separated. Referring now to FIG. 3, one embodiment of a heating station 202 of the converter 100 is schematically depicted. Each of the heating stations 202 may include one or more heating elements 301. As illustrated in FIG. 3, in embodiments, the heating element 301 may include one or more burners 302, which are used to heat targeted regions of the glass tube 102 prior to a forming operation performed at the forming station 204 (FIG. 2) or separating operation performed at the separating station 206 (FIG. 2). Although FIG. 3 depicts a single burner 302, it is understood that a plurality of burners 302 may be employed in a single heating station 202. Each burner 302 may be fluidly coupled to a fuel gas supply 304, an oxygen supply 306, and, optionally, an air supply 308. Examples of fuel gases for the burner 302 may include, but are not limited to hydrogen, hydrocarbon fuel gases such as methane, propane, and butane for example, other fuel gases, or combinations of these.

Each burner 302 may include a fuel control valve 310 to control the flow rate of fuel gas to the burner 302. Each burner 302 may also include an oxygen control valve 312 to control the mass flow rate of oxygen to the burner 302. Each burner 302 may further include an air control valve 314 for optionally controlling a flow rate of air to the burner 302. The burner 302 combusts the fuel gas in the presence of oxygen and/or air to produce a flame that heats at least the target region of the glass tube 102. Although the heating stations 202 of the converter 100 are described herein as heating the glass tube 102 using burners, it is understood that other heating elements or methods other than burners may be used to heat the glass tube 102. Other heating elements may include, but are not limited to, lasers such as CO₂ lasers for example, induction heaters, other heating devices, or combinations of these.

The heating station 202 may further include a heating element positioner 318 coupled to the burner 302. The heating element positioner 318 may be operable to positon the burner 302 vertically (e.g., in the +/−Z direction of the coordinate axis in FIG. 3), horizontally (e.g., in the X-Y plane identified by the coordinate axis in FIG. 3), or a combination of these directions relative to the glass tube 102 in the heating station 202. In embodiments, each heating element positioner 318 may include one or a plurality of servo motors operable to automatically and/or incrementally adjust the position of the burner 302 in one or a plurality of directions. Any other type of positioner that is or will become commercially available may be used for the heating element positioner 318. The heating element positioner 318, fuel control valve 310, oxygen control valve 312, air control valve 314, or combinations of these may be communicatively coupled to the control system 402 to enable the control system 402 to control the vertical position, horizontal position, heat output, or combinations thereof of the heating elements 301.

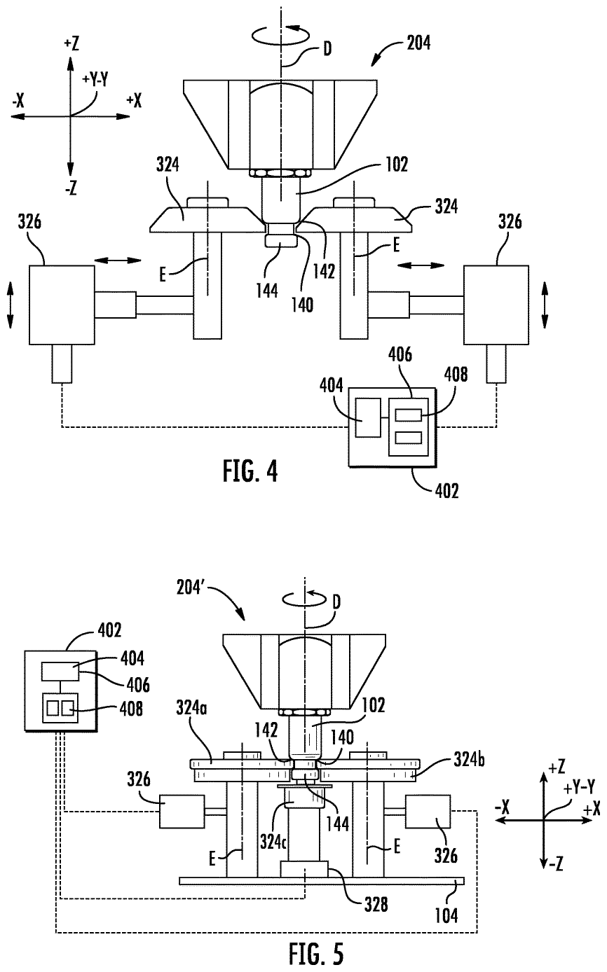

Referring again to FIG. 2, the forming stations 204 of the main turret 108 may be positioned downstream of the piercing station 212 and one or more heating stations 202 in the direction of translation 222. The one or more forming stations 204 may iteratively shape the glass tube 102 to form one or more features of the finished glass article. The forming stations 204 of the main turret 108 may shape the working end 150 (FIG. 4) of the glass tube 102, which has been heated in upstream heating station 202, to form features at one end of the glass articles 103, and the forming stations 204 of the secondary turret 114 may shape the other end of the glass articles 103 after the glass article 103 has been separated from the glass tube 102. In embodiments, the converter 100 may be used to produce glass articles 103 that are vials, and the forming stations 204 of the main circuit 116 may include one or more shoulder forming stations, flange forming stations, flange finishing stations, or combinations of these with one or more heating stations 202 positioned before each of the forming stations 204.

The forming stations 204 of the main turret 108 can form features at a first end of the glass article 103. Referring again to FIG. 2, once the glass article 103 is separated from the glass tube 102 at the separating station 206, the glass article 103 may be transferred to the secondary processing stations 112 of the secondary turret 114. The secondary processing stations 112 may include one or more forming stations 204 for forming a second end of the glass article 103, which is opposite the first end of the glass article 103. For example, the forming stations 204 of the secondary processing stations 112 may form one or more features at a bottom (second end) of the glass article 103.

Referring now to FIGS. 4 and 5, examples of forming stations 204 of the converter 100 are schematically depicted. Each forming station 204 may include one or more forming tools 324, which may be rotatable relative to the base 104 (FIG. 1) about tooling axis E. When passed into the forming station 204, the glass tube 102, which has been heated in a prior heating station 202, is rotated by the holder 130. The forming tools 324 may engage with the glass tube 102 as it rotates. When engaged, contact of the forming tools 324 with the heated glass tube 102 may form the glass tube 102 into the desired shape. The forming tools 324 may be contacted with the glass tube 102 for an active time of the forming tools 324. Upon expiration of the active time, the forming tool actuators 326 may withdraw the forming tools 324 from engagement with the glass tube 102. FIG. 4 schematically illustrates an embodiment of a forming station 204 for forming a shoulder 142 of a glass vial. FIG. 5 schematically depicts an exemplary embodiment of a forming station 204′ for forming a flange 144 of a glass vial. The forming station 204′ for forming the flange 144 may comprise three forming tools 324a, 324b, and 324c. Other types of forming tools 324 may be employed in the forming station 204 depending on the desired features of the glass article 103.

Referring again to FIG. 4, the forming tool actuators 326 may be operable to move the forming tools 324 into and out of engagement with the glass tube 102. Moving the forming tools 324 into and out of engagement with the glass tube 102 may control the contact timing of the forming tools 324 with the glass tube 102. The contact timing of the forming tools 324 with the glass tube 102 refers to the timing of engaging and disengaging each of the forming tools 324 in a forming station 204 with the glass tube 102. Adjusting the contact timing of the forming tools 324 may adjust the total contact time of each of the forming tools 324 in contact with the glass tube 102. The contact time refers to the duration of time that the forming tools 324 are engaged or in contact with the glass tube 102.

The forming tool actuators 326 may further be operable to change the position of the forming tools 324 axially (i.e., in the +/−Z direction of the coordinate axis in FIG. 3), transversely (i.e., horizontally or in the X-Y plane identified by the coordinate axis in FIG. 4), or a combination of these directions relative to the glass tube 102 in the forming station 204. The forming position of the forming tools 324 refers to the forming tool position when the forming tool 324 is engaged with the glass tube 102. In embodiments, each forming tool actuator 326 may include one or a plurality of servomotors operable to adjust, automatically and/or incrementally, the positions of the forming tools 324 in one or a plurality of directions of the coordinate axis in FIG. 4. Any other type of positioner that is or will become commercially available may be used as at least a portion of the forming tool actuator 326. The forming tool actuators 326 may be communicatively coupled to the control system 402 to enable the control system 402 to change the axial position, transverse position, or both of the forming tools 324 when in the forming position. The axial (i.e., +/−Z direction) and/or transverse position (i.e., position in X-Y plane) of the forming tools 324 relative to glass tube 102 refers to the position of the forming tools 324 when the forming tools 324 are engaged with the glass tube 102.

Referring now to FIG. 5, another embodiment of a forming station 204 for forming the flange 144 of a glass article 103 that is a glass vial is schematically depicted. The forming station 204 may include forming tools 324a and 324b, which may be outer forming tools. Each of forming tools 324a and 324b may be operatively coupled to outer forming tool actuators 326a and 326b. The forming station 204 may include an inner forming tool 324c. The inner forming tool 324c may be operatively coupled to an inner forming tool actuator 328, which may be operable to actuate the inner forming tool 324c axially into an opening in the working end 150 of the glass tube 102. The inner forming tool actuator 328 may further be operable to modify an axial position (i.e., position in the +/−Z direction of FIG. 5), a horizontal position (i.e., a position in an X-Y plane of the coordinate axis in FIG. 5), or both of the inner forming tool 324c when the inner forming tool 324c is actuated into engagement with the glass tube 102 (i.e., actuated in the +Z direction into the opening in the working end of the glass tube).

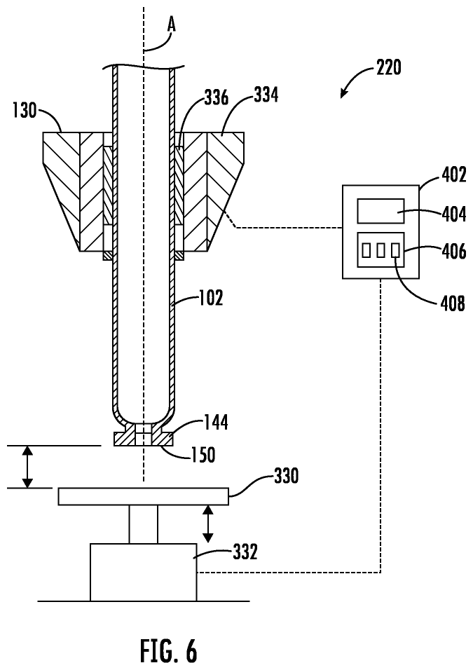

Referring again to FIG. 2, the tube length drop station 220 may be positioned after the forming stations 204 of the main circuit 116 and between the forming stations 204 and the separating station 206. Referring to FIG. 6, the tube length drop station 220 may be operable to drop the glass tube 102 having the partially formed glass article at the working end 150 of the glass tube 102 downward (i.e., in the −Z direction of the Coordinate axis in FIG. 6), thereby positioning the glass tube 102 for separating the glass article 103 from the glass tube 102 at the separating station 206. The tube length drop station 220 may determine the overall height attribute of the finished glass articles 103.

Referring now to FIG. 6, one embodiment of the tube length drop station 220 is schematically depicted. The tube length drop station 220 may comprise a mechanical stopper 330 that is axially spaced apart in the −Z direction of the coordinate axis of FIG. 6. The mechanical stopper 330 may be coupled to a stopper positioner 332, which may be operable to change the position the mechanical stopper 330 in the axial direction relative to the glass tube 102 (+/−Z direction of the coordinate axis in FIG. 6). The mechanical stopper 330 may be spaced apart from the working end 150 of the glass tube 102 in the axial direction (i.e.,-Z direction of the coordinate axis of FIG. 6) by a distance G. The distance G may be selected to produce the desired final overall height of the glass article 130. In embodiments, the holder 130 may be a chuck 334 having a gripper 336 operable to grip the glass tube 102 so that the glass tube 102 can be maintained at the proper height and rotated during converting. The chuck 334 may be communicatively coupled to the control system 402, which may be operable to actuate the gripper 336 of the chuck 334.

During operation of the tube length drop station 220, the control system 402 may cause the gripper 336 of the chuck 334 to loosen. Loosening the gripper 336 of the chuck 334 may allow the glass tube 102 to slide or drop axially (i.e., in the −Z direction of the coordinate axis of FIG. 6) until the glass tube 102 contacts the mechanical stopper 330. Thus, in the tube length drop station 220, the glass tube 102 is dropped from a first axial position to a second axial position relative to the stationary axial position of the holder 130. After the glass tube 102 has dropped and stopped at the mechanical stopper 330, the control system 402 may re-engage the gripper 336 of the chuck 334 to secure the glass tube 102 at the second position. When the converter 100 is vertically oriented, the force of gravity may be sufficient to cause the glass tube 102 to drop into the second position. When the converter 100 is horizontally oriented, the converter 100 may comprise a separate glass tube actuator operable to move the glass tube axially relative to the holder 130 into the second position. In embodiments, the tube length drop function may be incorporated into the last forming station 204 upstream of the separating station 206 instead of the converter 100 having a separate and dedicated tube length drop station 220. In the last forming station 204, the glass tube 102 may be dropped to the proper height for separating immediately at the end of the last flange forming station and before translating the holder 130 and glass tube 102 into the next processing station 106. Although described herein in the context of a separate tube length drop station 220, in embodiments, the mechanical stopper 330 and stopper positioner 332 may be incorporated into the final forming station 204 prior to separation so that the tube drop function can be accomplished immediately at the conclusion of the final forming operation before translating the glass tube 102 into the next downstream processing station.

Referring again to FIG. 2, the separating station 206 may be disposed downstream of the last forming station 204 in the direction of translation 222 of the main turret 108. One or a plurality of heating stations 202 may be positioned upstream of the separating station 206 and between the last forming station 204 and the separating station 206. At the separating station 206, the formed glass article 103 (FIG. 1) may be separated from the glass tube 102 (FIG. 1). The separating station 206 may also be the processing station 106 at which the partially formed glass article 103, once separated, is transferred to the secondary turret 114 (FIG. 1) for processing in the secondary processing stations 112.

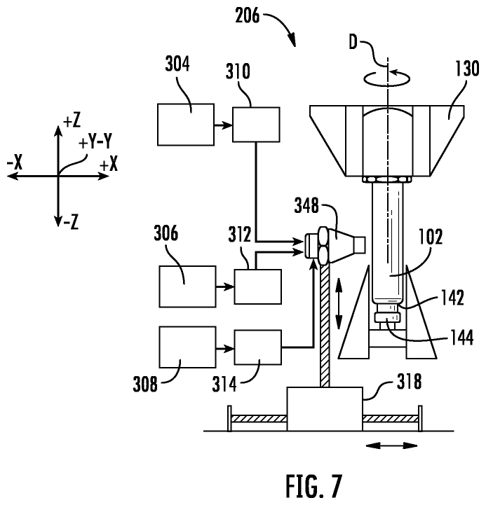

Referring now to FIG. 7, one embodiment of a separating station 206 of the converter 100 is schematically depicted. The separating station 206 depicted in FIG. 7 is a thermal separating station and may be positioned after one or more heating stations 202 in the direction of translation 222 of the main turret 108. The heating stations 202 positioned before the separating station 206 may heat the glass tube 102 to make the glass viscous. The separating station 206 may include a separating burner 348. The separating burner 348 may have any of the features previously described for burners 302, including but not limited to a fuel gas control valve 310, an oxygen control valve 312, and/or an air control valve 314. While the glass tube 102, which has been made viscously deformable by the previous heating stations 202, is rotated by the holder 130 about the center axis D of the glass tube 102, the separating burner 348 may be engaged with the outer surface 140 of the glass tube 102 to heat the glass tube 102 to a temperature at which the viscosity of the glass causes the partially formed glass article to separate from the glass tube 102. Once separated from the glass tube 102, the partially formed article may be transferred to the secondary turret 114 (FIG. 1) or discharged from the converter 100. Although shown in FIG. 7 as a thermal separating station, the separating station 206 may also be a non-thermal separating station such as a separating station using score and break techniques, as may be used for syringes and cartridges for example.

Like the heating station 202, the separating station 206 may also include a heating element positioner 318 coupled to the separating burner 348. The heating element positioner 318 may be operable to positon the separating burner 348 vertically (e.g., in the +/−Z direction of the coordinate axis in FIG. 3), horizontally (e.g., in the X-Y plane identified by the coordinate axis in FIG. 7), or a combination of these directions relative to the glass tube 102 in the separating station 206. The heating element positioner 318, fuel control valve 310, oxygen control valve 312, air control valve 314, or combinations of these may be communicatively coupled to the control system 402 (FIG. 3) to enable the control system 402 to control the vertical position, horizontal position, heat output, or combinations of these of the separating burner 348. When the separating station 206 is a score and break separating station, the separating station 206 can include one or more scoring tools and/or breaking tools and may further include tool actuators operable to change the positioning of the scoring tools and/or breaking tools.

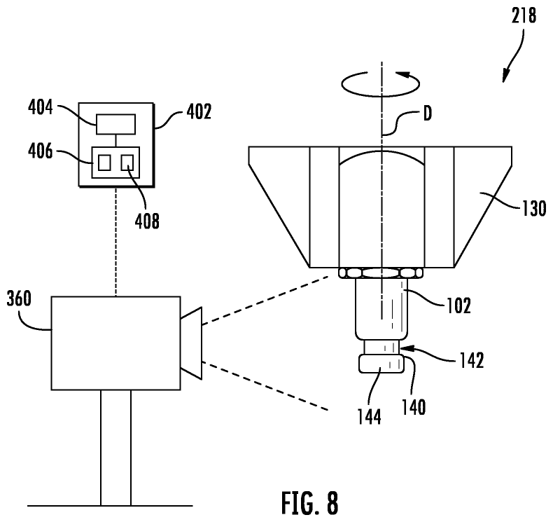

Referring again to FIG. 2, in embodiments, the converter 100 may include a piercing station 212. The piercing station 212 may be positioned on the main circuit 116 downstream of the separating station 206 in the direction of translation 222 of the main turret 108. At the piercing station 212, a meniscus of the glass tube 102, which may be previously formed in the separating station 206, may be pierced, thereby reopening the working end of the glass tube 102. Referring now to FIG. 8, one embodiment of a piercing station 212 of the converter 100 is schematically depicted. The piercing station 212 may be positioned after the separating station 206 in the direction of translation 222 of the main turret 108. As previously described, thermal separation of the article 103 from the glass tube 102 in the separating station 206 may cause a meniscus 350 of glass to form across the working end 150 of the glass tube 102. In the piercing station, the meniscus 350 is pierced in preparation for forming the next article at the working end 150 of the glass tube 102.

In embodiments, the piercing station 212 may include a piercing burner 352. The piercing burner 352 may be positioned below the working end 150 of the glass tube 102 and may be oriented toward the working end 150 of the glass tube 102. The piercing burner 352 may be fluidly coupled to one or more of a fuel gas supply 304, oxygen supply 306, air supply 308, or combinations of these. The fuel gas supply 304, the oxygen supply 306, and the air supply 308 were previously discussed in relation to the burner 302 of FIG. 3. The piercing station 212 may also include a fuel gas control valve 310, oxygen control valve 312, and/or air control valve 314 for controlling heat output from the piercing burner 352. When main turret 108 indexes the glass tube 102 into the piercing station 212, the flame from the piercing burner 352 heats the meniscus 350 of glass and melts the meniscus 350 to pierce the meniscus 350 and re-open the working end 150 of the glass tube 102. In embodiments, the meniscus 350 may be pierced by directing a stream of gas, such as compressed air, nitrogen, argon, or other gas, at the meniscus 350 or across the meniscus 350. In embodiments, mechanical means or other methods may be used to pierce the meniscus 350 instead of using a piercing burner 352. Various methods of piercing the meniscus 350 are disclosed in U.S. Pat. No. 10,968,133, entitled “METHODS FOR MINIMIZING SHR IN GLASS ARTICLES BY PRODUCING A GAS FLOW DURING PHARMACEUTICAL PART CONVERTING,” granted Apr. 6, 2021; co-pending U.S. application Ser. No. 16/197,187, entitled “SYSTEMS AND METHODS FOR MINIMIZING SHR FROM PIERCING DURING PHARMACEUTICAL PART CONVERTING USING A GAS FLOW,” filed Nov. 20, 2018; co-pending U.S. application Ser. No. 16/197,971, entitled “SYSTEMS AND METHODS FOR MINIMIZING SHR FROM PIERCING DURING PHARMACEUTICAL PART CONVERTING USING NEGATIVE PRESSURE EVACUATION,” filed Nov. 21, 2018; and co-pending U.S. application Ser. No. 16/198,041, “SYSTEMS AND METHODS FOR MINIMIZING SHR FROM PIERCING FROM PHARMACEUTICAL PART CONVERTING USING PULSED EJECTION,” filed Nov. 21, 2018, the entire contents of all of which are incorporated by reference in the present disclosure. Positioners, control valves, and other control devices may be incorporated into the piercing station 212 and communicatively coupled to the control system 402 (FIG. 1) to control various operating parameters of the piercing station 212.

Referring again to FIG. 2, converter 100 may further include a measuring station 218, at which at least one measurement device may be used to measure one or more attributes of the glass tube 102, such as the diameter and thickness for example, or one or more dimensions of the features of the glass article 103 formed by the forming stations 204. Attributes of the glass article 103 comprising feature dimensions may include, but are not limited to, flange thickness, flange length, neck length, neck thickness, overall article height, flange inner diameter, flange outer diameter, flange height, top height, bottom flange angle, top flange angle, eccentricity, article inside or outside diameter, shoulder thickness, shoulder angle, shoulder radius, other feature dimension, or combinations thereof. One or more cosmetic attributes of the glass tube 102 or glass article 103 may also be assessed in the measuring station 218. Cosmetic attributes may include, but are not limited to defects in one or more features (e.g., defects in the flange, neck, etc.) of the glass article 103, overall desirability, or combinations of these. Overall desirability may be a composite property based on a plurality of other dimension or cosmetic attributes measured for the glass article 103. One or more measuring stations 218 may be in the main circuit 116, the secondary circuit 118, or both. In embodiments, the measuring station 218 may be positioned in the main circuit 116 directly after the last forming station 204 so that the dimensions are measured while the glass tube 102 is still at elevated temperature. Alternatively or additionally, in embodiments, the measuring station 218 may be positioned after one or more cooling stations 210 to measure the dimensions of the glass tube 102 and/or glass article 103 at a lower temperature. In embodiments, the secondary circuit 118 of the converter 100 may include a measuring station 218.

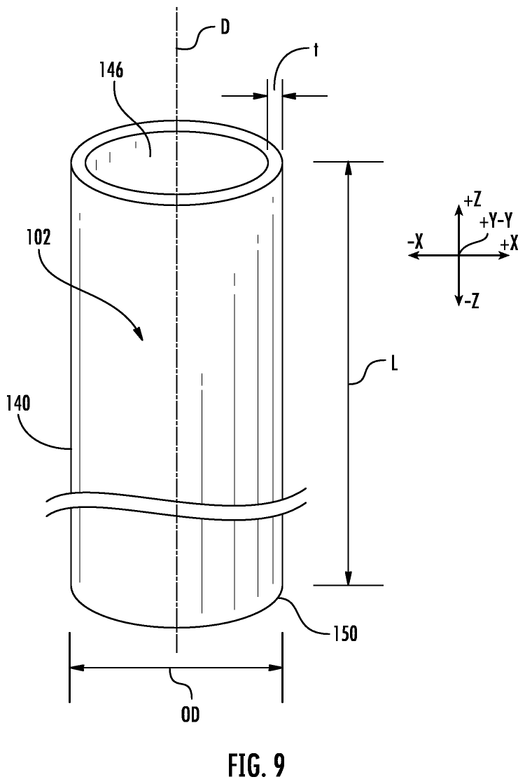

Referring now to FIG. 9, one embodiment of a measuring station 218 is schematically depicted. The measuring station 218 may include one or a plurality of measurement devices 360 positioned to measure one or a plurality of attributes of the glass tube 102, and glass article 103, or both. The attributes may include one or more physical dimensions, one or more cosmetic properties, or both of the glass tube 102, the glass article 103, or both. The measurement devices 360 may be communicatively coupled to the control system 402 to transmit information relating to the one or more attributes of the glass tube 102, glass article 103, or both to the control system 402. The measurement device 360 in the measuring station 218 may be any of the measurement devices described herein. In embodiments, the measurement device 360 may be a thermal imaging device. Examples of thermal imaging devices for measuring attributes and properties of the glass tube 102 or the features formed at the working end 150 of the glass tube 102 can be found in U.S. Pat. No. 10,773,989, granted Sep. 15, 2020, and entitled “SYSTEMS AND METHODS FOR MEASURING THE TEMPERATURE OF GLASS DURING TUBE CONVERSION,” the entire contents of which are incorporated by reference herein.

Referring again to FIG. 2, one or more cooling stations 210 may be positioned after the forming stations 204 in the direction of translation 222 of the main turret 108. The main circuit 116 may also include a tube loading station 214 for loading a new length of glass tube 102 feedstock from the glass tube loading turret 110 to the main turret 108 (FIG. 1).

FIGS. 3-9 include schematic illustrations of several different examples of processing stations 106 that may be utilized in the converter 100. However, it should be understood that other processing stations 106 having different structures, combinations of structures, or functions, may be utilized to achieve the desired conversion of the glass tube 102 into one or more glass articles. The previous description of the processing stations 106 of the main circuit 116 and the secondary processing stations 112 of the secondary circuit 118 may represent a typical converter 100 for producing vials from the glass tube 102. However, it is understood that more or fewer processing stations 106 and secondary processing stations 112 may be utilized to make vials having different shapes or features or other glass articles, such as cartridges, syringes, ampoules, or other pharmaceutical glass articles. Additionally, it is understood that the processing stations 106 and secondary processing stations 112 may be arranged in any of a number of different orders and/or configurations in order to produce differently shaped glass articles.

Referring again to FIG. 1, as previously discussed, the converter 100 can further include a control system 402 communicatively coupled to the converter 100 and to the at least one measurement device 360. The control system 402 may include one or a plurality of processors 404, one or a plurality of memory modules 406 communicatively coupled to the processor 404, and machine readable and executable instructions 408 stored on at least one memory module 406. The machine readable and executable instructions 408, when executed by at least one processor 404, may cause the control system 402 to conduct any of the method steps disclosed herein and/or operate any of the processing stations 106, measurement devices 360, or other control devices of the converter 100.

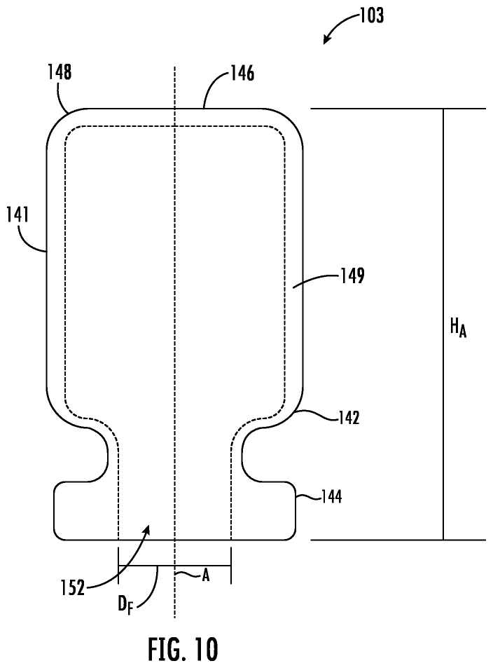

Referring now to FIG. 10, the glass tube 102 may be an elongated hollow cylindrical tube made from glass. The glass tube 102 may have a circular cross-sectional shape and may have an outer surface 140, an inner surface 146, and a thickness t. The thickness t of the glass tube 102 may be a radial distance between the inner surface 146 and the outer surface 140 of the glass tube 102. The glass tube 102 may have a length L in the +/−Z direction of the coordinate axis of FIG. 10. The glass tube 102 may have an outside diameter OD as shown in FIG. 10. As previously discussed, the glass tube 102 may be rotated about center axis D of the glass tube 102 throughout the converting process. The working end 150 of the glass tube 102 is the end of the glass tube 102 that is oriented in the −Z direction of the coordinate axis in FIG. 10 when the glass tube 102 is secured in the holder 130 of the converter 100. The non-working end of the glass tube 102 is the end opposite the working end 150 (i.e., the end of the glass tube 102 in the +Z direction of the coordinate axis of FIG. 10.

Referring again to FIGS. 1 and 2, in general operation of the converter 100 to produce glass articles 103 from glass tubes 102, the main turret 108 may index or move the glass tubes 102, which are secured in the holders 130, into a processing station 106. A specific operation, such as heating, forming, piercing, separating, cooling, dropping, feeding, measuring, etc. may be performed on the glass tubes 102 at each of the processing stations 106. The converter 100 may be tuned so that all of the processing stations 106 complete their operations within the dwell time. At the end of the dwell time, the main turret 108 may index the glass tubes 102 to the next processing stations 106 during an index time. For an indexing converter, the total time per part per station, as used in this disclosure, is the sum of the dwell time and the index time.

In embodiments, the converter 100 may be a continuous converter operable to move the glass tubes 102 and holders 130 continuously through the plurality of processing stations 106. In embodiments, the heating elements, burners, forming tools, measurement devices, and other elements of the converting process may move with the glass tube 102 as it passes through the processing station 106. For both an indexing converter and a continuous converter, an “active time” of the processing station is a duration of time that the glass tube 102 is maintained in engagement with at least one heating element, at least one forming tool, at least one cooling nozzle, or other device while in the processing station 106.

Examples of converters 100 for converting glass tube 102 into glass vials include the Vial Forming Machine Models RP16 or RP18 with Automatic Tube Feeder manufactured by AMBEG Dr. J. Dichter GmbH, which includes sixteen processing stations 106 in the main circuit 116 and eight secondary processing stations 112. Other examples include the Vial Forming Machine Model RP32 manufactured by AMBEG Dr. J. Dichter GmbH, which has thirty-two processing stations 106 in the main circuit 116 and two secondary circuits 118 with eight secondary processing stations 112 in each secondary circuit 118, and the Zeta 098 Vial Forming Machine manufactured by Euromatic S.R.L., which has 36 processing stations. Another example may include the Zeta 103 Cartridge Forming Machine manufactured by Euromatic S.R.L., which is a converter for converting glass tube into glass cartridges. The cartridge converter may have similar characteristics to the previously described vial converters but may be utilized to produce glass articles having cartridge form factors instead of vials.

Although described in the context of a converter 100 for producing glass vials from glass tube 102, it should be understood that the converter 100 may be configured to produce one or more other articles, such as other types of pharmaceutical containers or articles, by changing the forming tools 324 and/or the order or configuration of processing stations 106 in the main circuit 116 or secondary processing stations 112 in one or more secondary circuits 118. Pharmaceutical articles may include, but are not limited to vials, vacutainers, cartridges, syringes, ampoules, jars, or other glass pharmaceutical articles.

Current converting methods for making glass articles from glass tubes using a converter machine have long relied on manual observation of attributes of the glass articles and manual adjustment (or pseudo manual adjustment since the actuators themselves are dial adjusted stages or servos driven by PLC). For instance, converting in glass vial production has long relied on manual observation of the vial height attribute behavior followed by manual adjustment. The converting process can be normally slow drifting but may be occasionally punctuated by sudden shifts in measured attributes of the glass articles. Further, a typical converter has many setpoints, such as but not limited to gas flow rates, gas mixtures, burner positions, forming tool wheel and pin positions, contact timing, tube length drop height, and other setpoints, that must be determined in the effort to make acceptable yields. Even after nominal setpoints are determined, changes in incoming material, component wear, and many other disturbances necessitate that actuator set points themselves be adjusted in real time to compensate the process. The source of the disturbances are often not known and even if known, some are not economically feasible to remove as compared to the development and application of a feedback control solutions. Thus, the greatest achievable yield can vary over time and is dependent on the evolving shape over time of the distributions of the various measured attributes of the glass articles.

As a non-limiting example, when the glass article is a glass vial, the vial height is one important dimension of the glass vial to maintain within specification. Referring again to FIG. 6, At nearly the end of or after the flange forming process for producing the flange 144 of the glass vial, the grippers 336 of the chuck 334 briefly relax to allow the glass tube 102 to drop by a distance about the intended height of the final glass vial until the working end 150 of the glass tube 102 contacts the mechanical stopper 330. The position of the mechanical stopper 330 may be set by the stopper positioner 332, which may be a servomotor. In embodiments, the position of the mechanical stopper 330 generally has a direct relationship with the final height of the glass vial. The glass tube 102 then proceeds to the separation process and is transferred to a secondary turret 114 (FIG. 1) for forming the bottom of the glass vial. Referring now to FIG. 10, the resulting heights HA of the glass vials 141 can be quite variable, which variability may be a function of the particular bottom forming chuck used. Because of chuck-to-chuck variability, the distribution in the measured heights of the glass vials 141 can be a heavy tailed distribution. Another non-limiting example may include inner flange diameter DF or other measured attributes of the glass tubes 102 and/or glass articles 103. The distributions in various measured attributes can have non-Gaussian shapes, such as being long tailed or multimodal, which can make setpoint control challenging. The distributions in measured attributes can also be subject to sudden shifts due for example to maintenance operations, such as but not limited to replacement of worn parts, cleaning operations, or other maintenance activities.

The present application is directed to methods of controlling one or more operations of the converter by shifting the distribution of a measured attribute to attain the greatest yield of conforming product. In the control methods disclosed herein, the distribution of the measured attribute is shifted between upper and lower specification limits. The distribution shifting control method may produce the greatest yield of conforming glass articles regardless of the shape of the distribution of the measured attributes and regardless of whether the distributions are highly skewed. The control methods disclosed herein may be applied to any measured attribute of the glass articles. As non-limiting examples, the control methods can be used for height and inner flange diameter of glass articles that are glass vials, among other attributes.

Referring now to FIG. 1, according to embodiments disclosed herein, the methods for controlling a converter 100 for producing glass articles 103 from glass tubes 102 include operating the converter 100 to produce the glass articles 103 from the glass tubes 102. The converter 100 comprises a plurality of processing stations 106, and operating the converter 100 comprises translating the glass tubes 102 through each of the plurality of processing stations 106 in succession. The methods may further include measuring an attribute of the glass articles 103 during or after conversion, where the attribute is subject to gradual change over time, a sudden change, or both. The methods may further include developing an attribute distribution from measured values of the attribute and shifting the attribute distribution within a specification range for the attribute, wherein shifting the attribute distribution increases a yield of the glass articles 103. Shifting the attribute distribution within the specification range may comprise adjusting at least one process setting of the converter, where adjustment of the at least one process setting shifts the attribute distribution.

The control methods disclosed herein are an enhancement to conventional feedback control of a process based on a specification value of the attribute. Control methods based on conventional feedback control to a specification value of the attribute generally include measuring the attribute downstream of the process, calculating an error between the measured value of the attribute and a target value of the attribute, which corresponds to the fixed specification value of the attribute from the product specification, and then developing a control response based on the error between the measured value and the target value. The methods disclosed herein focus on moving the target value of the attribute within the specification range so that the greatest number of glass articles fall within the specification range, thereby improving yield of the glass articles. Thus, the target value may be moved away from the specification value of the attribute from the product specification in order to improve the yield of the glass articles.

In conventional feedback control systems, the target value of an attribute may be based on the specification value in the product specification, which may be bound between an upper specification limit and a lower specification limit on the attribute. For attributes having a normal distribution about a mean value, controlling the mean value of the attribute distribution to the target value equal to the specification value may ensure the largest number of glass articles fall between the upper and lower limits of the specification range. These conventional control methods work well with normal attribute distributions that are generally symmetric and centered about a mean value. However, when the distribution of measured attribute values is non-normal, such as being asymmetric (e.g., long tailed), multi-modal, or having other irregular patterns, feedback control based on a the specification value of the attribute may still result in a significant percentage of non-conforming glass articles (e.g., percentage of the glass articles having measured attributes outside the specification range for the attribute).

The present methods look at the attribute distribution as a whole and the shape of the attribute distribution and determine the target value of the attribute between the upper and lower limits of the specification range based on shifting the attribute distribution to fit as many of the glass articles within the specification range as possible, regardless of where the specification value of the attribute lies between the upper and lower limits of the specification range. In other words, instead of setting the target value of the attribute to the specification value from the product specification, the methods of the present disclosure operate by moving the target value itself within the specification range, and relative to the specification value from the product specification, to get the greatest percentage of the measured attributes in the attribute distribution within the specification range for the attribute (e.g., increase or maximize the yield of the glass articles). Once the target value of the attribute that increases the yield of the glass articles is determined, a control response is developed to adjust one or more process settings to move the attribute distribution to correspond to the new target value. The control response to shift the attribute distribution may then be determined through various control methodologies, such as but not limited to PID control, lead/lag control, model predictive control, or other control methods.

In the methods of the present disclosure, the adjustment of the process setting(s) shifts the mean of the attribute distribution up or down within the specification range to the updated target value of the attribute, which causes all the other measured values in the attribute distribution to shift within the specification range. Thus, the entire attribute distribution is moved within the specification range to increase the number of conforming glass articles having attributes falling within the specification range. Although discussed in the context of the mean of the attribute distribution, it is understood that shifting the attribute distribution can be based on other characteristics of the attribute distribution, such as but not limited to a median, maximum measured value, minimum measured value, standard deviation, spread between the minimum and maximum measured values, or other characteristic of the attribute distribution.

The control methods disclosed herein may be well suited for processes in which dynamics can be ignored in the control relationship between the process settings and the measured attributes. This is typical in discrete part manufacturing, such as but not limited manufacturing of pharmaceutical vials or other pharmaceutical containers. The control methods disclosed herein may also be applicable to processes in which the control relationship between process settings and measured attributes is stable over time. Slow drifts in the control relationship are permissible with additional methods to re-characterize the control relationship periodically. The control methods disclosed herein may be suitable for quality attributes that are measureable so that an estimate of the attribute distribution can be developed. Finally, the control methods disclosed herein may be suitable for measured attributes having an upper specification limit, a lower specification limit, or both an upper specification limit and a lower specification limit.

The methods disclosed herein may enable increasing the yield of conforming glass articles by shifting the attribute distribution to fit the greatest number of measured attributes in the distribution within the specification range. The control methods disclosed herein may be applied to attribute distributions of any shape, since the shifting acts on a direct set of measurements used to estimate the true underlying attribute distribution. The methods disclosed herein reduce reliance on human intervention and so decrease variation in the process caused by operator variability. The control methods can be implemented in a fully automated approach or can be incorporated into a control strategy having a human operator in the control loop. Fully automating the control methods disclosed herein may improve efficiency by not requiring an operator to take time and “see what the current state is,” but full automation of the control method may be less aware of the context. Thus, full automation of the control methods may be applicable to converting processes in which major assignable causes of non-conforming products have already been removed. Some unusual behavior of converters 100 can be difficult to capture algorithmically, but can be observed and noted by human operators. The control methods disclosed herein can be adapted to allow for varying degrees of human interaction, which can provide the opportunity to observe these unusual behaviors and account for them in controlling the converting process. The control methods can be applied to a single attribute of the glass articles or to a plurality of attributes of the glass articles.

The control methods disclosed herein for producing glass articles from glass tubes can be conducted with a system comprising a converter, one or more measurement devices, one or more control devices, and a control system communicatively coupled to the converter, the measuring devices, and the control devices. Referring again to FIGS. 1 and 2, a system 400 for producing a plurality of glass articles 103 from glass tube 102 includes the converter 100 having the plurality of processing stations 106, such as but not limited to at least one heating station 202, at least one forming station 204, and a separating station 206. In embodiments, the converter 100 may further include a tube length drop station 220. As previously discussed, the converter 100 may be operable to translate the glass tube 102 through each of the plurality of processing stations 106. The converter 100 may include the plurality of holders 130. Each of the holders 130 may be operable to secure a glass tube 102 and rotate the glass tube 102 about the center axis D of the glass tube 102. Translating the glass tube 102 through each of the processing stations 106 in sequence may form one or more features of the glass articles 103 and may separate the glass articles 103 from a working ends 150 of the glass tube 102. It is understood and intended that the converter 100 may include any of the features, processing stations, or operating parameters previously described herein for converter 100. The system 400 further includes at least one measurement device 360 operable to measure one or more attributes of each of the glass articles 103 produced from the glass tube 102. The converter 100 further includes at least one control device (not shown in FIG. 1 or 2) operable to change a process setting that effects the attribute of the glass articles 103. The converter 100 may further include a control system 402 communicatively coupled to the converter 100, the at least one measurement device 360, and the control device. The control system 402 may be operable to conduct one or more of the method steps disclosed herein.

Referring again to FIG. 1, the measure measurement device 360 may be positioned to measure the attribute of the glass articles 103 during or after converting. The measurement devices 360 may enable 100% online inspection of various dimensions and cosmetic attributes of the glass tube 102, glass articles 103, or both to provide real time data on measured attributes of the glass articles and/or glass tubes 102 to the system 400. In embodiments, the measurement device 360 may be coupled to the main turret 108, the secondary turret 114, one or more of the processing stations 106, or combinations thereof so that the measurement device 360 may be operable to measure the attributes of the glass article 103 and/or glass tubes 102 during the converting process on the converter 100. The measurement devices 360 may be disposed in one or a plurality of measuring stations 218, which may be in the primary circuit, the secondary circuit, or both. Additionally or alternatively, in embodiments, the converter 100 may include one or a plurality of measurement devices 360 positioned at one or more processing stations 106 that is not a measuring station 218, such as but not limited to a heating station 202, forming station 204, separating station 206, cooling station, piercing station, or other type of processing station. Additionally or alternatively, one or more of the measurement devices 360 may be coupled to one of the plurality of holders 130 and may be translated through a plurality of the processing stations 106 with the holder 130. In embodiments, the converter 100 may include a plurality of measurement devices 360, each of which may be coupled to a processing station 106 and/or coupled to one of the plurality of holders 130 for translation through the plurality of processing stations 106 with the holder 130 and the glass tube 102. Additionally or alternatively, the measurement devices 360 may be disposed downstream of the converter 100, such as at a quality control station downstream from the converter 100. In embodiments, the measurement device 360 may be disposed downstream of the converter 100, such as after ejecting the glass articles 103 from the secondary turret 114 or after an annealing process (not shown) downstream of the converter 100.

The measurement devices 360 may be operable to measure one or a plurality of attributes of the glass tube 102, one or a plurality of attributes of features of a partially formed glass article at the working end 150 of the glass tube 102, one or a plurality of attributes of each of the glass articles 103 produced from the glass tubes 102, or a combination of these. The attributes of the plurality of glass tubes 102, glass articles 103, partially formed glass article 103, or combinations of these may comprise one or more temperatures of the glass tube 102, one or more dimensions of the glass tube 102, one or more dimensions of the plurality of glass articles 103 or features of the partially formed glass articles 103 formed at the working end 150 of the glass tube 102, one or more cosmetic attributes of the plurality of glass articles 103, or combinations of these. In embodiments, the measurement device 360 may be positioned and operable to measure one or more attributes of a glass preform at the working end 150 of the glass tubes 102. The glass preform refers to the heated portions of the glass tube 102 at the working end 150 of the glass tube 102 after the heating stations 202 and before the forming stations 204. In embodiments, the measurement devices 360 may be positioned and operable to measure one or more physical dimensions of the glass article 103, features of the partially formed glass articles 103, or combinations thereof.

The one or more measurement devices 360 may include any measurement devices capable of measuring one or more dimensions, temperatures, or cosmetic attributes of the glass tube 102 and/or glass articles 103 made therefrom. Measurement devices 360 may include but are not limited to optical measuring systems, laser measurement devices, measurement devices using sound waves or other electromagnetic waves, or other measurement technology. In embodiments, the measurement devices 360 may include a thermal imaging system, such as the thermal imaging systems disclosed in U.S. Pat. No. 10,773,989, entitled “SYSTEMS AND METHODS FOR MEASURING THE TEMPERATURE OF GLASS DURING TUBE CONVERSION,” filed on Mar. 22, 2018, the entire contents of which are incorporated by reference herein in their entirety. The thermal imaging systems may be operable to measure one or more temperatures and/or dimensions of the glass tube 102, glass article 103, or both during or after heating and forming the glass tube 102 into the glass articles 103. Additionally or alternatively, the measurement devices 360 may include one or more dimension measuring systems, such as one or more of a visual imaging system, a laser reflectometer, a laser gauge, an optical micrometer, or other measuring device operable to measure one or more dimensions of the glass tube 102, features of the partially formed glass article, finished glass article 103, or combinations of these. Other available measurement devices 360 for determining one or more temperatures, dimensions, cosmetic attributes, or combinations of these of the glass tube 102, the glass articles 103, or both are contemplated.

Referring now to FIGS. 1-8, control devices of the converter 100 that may be communicatively coupled to the control system 402 may include but are not limited to heating element positioners 318, fuel gas control valves 310, oxygen control valves 312, air control valves 314, forming tool actuators 326, outer forming tool actuators 326a and 326b, inner forming tool actuators 328, stopper actuator 332, chucks 334 of the holders 130, the main turret drive motor, drive motor(s) operatively coupled to the holders 130 for rotation of the glass tubes 102, timers, vent systems, other control devices, or combinations of these. The number and type of control devices may depend on the specific converter 100 being used and the number and type of processing stations 106 employed by the converter 100.

Referring again to FIG. 1, the system 400 for producing a plurality of glass articles from glass tube 102 may further include the control system 402 communicatively coupled to the converter 100. In particular, the control system 402 may also be communicatively coupled to the measurements devices 360 and the various control devices in the processing stations 106 of the converter 100. The control system 402 may comprise one or a plurality of processors 404, one or a plurality of memory modules 406 communicatively coupled to the processors 404, and machine readable and executable instructions 408 stored on the memory modules 406. The machine readable and executable instructions 408, when executed by the processor 404, may cause the system 400 to perform any of the actions and/or conduct any of the method steps disclosed herein, even if not explicitly described in the context of the machine readable and executable instructions 408. In embodiments, the machine readable and executable instructions 408, when executed by the processor 404, may cause the system 400 to at least automatically measure the attribute of the glass articles 103, develop an attribute distribution based on measured values of the attribute of the glass articles 103, determine whether a shift in the attribute distribution within a specification range for the attribute increases a yield of the glass articles 103, and when the shift in the attribute distribution increases the yield of the glass articles, shift the attribute distribution within the specification range for the attribute.

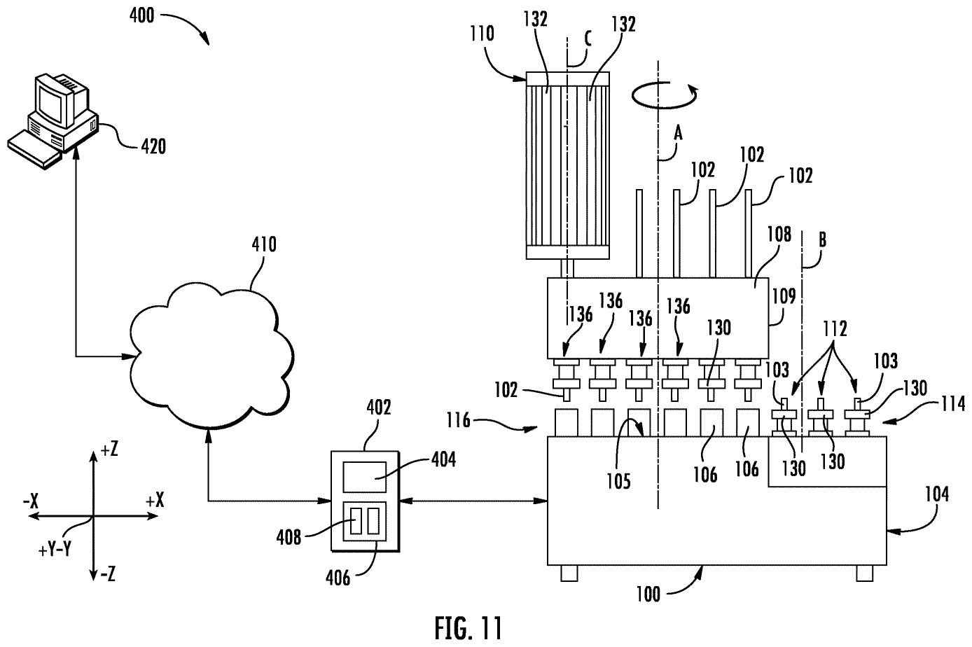

Referring now to FIG. 11, in embodiments, the system 400 can further include a display 430 operable to display a graphical user interface 432. The display 430 can be communicatively coupled directly to the control system 402 or can be in electronic communication with the control system 402 through a network 410. The display 430 may be a touch screen or may include one or more input devices (not shown) capable of enabling a user to enter information into the graphical user interface 432. The graphical user interface 432 may be operable to display information about the control system 402 and control sequence. The graphical user interface 432 may also be operable to receive input from a user (e.g., machine operator) and transfer the user input to the control system 402. In embodiments, the system 400 may further include one or more external computing devices 420 communicatively coupled to the control system 402 through the network 410. One or more of the external computing devices 420 may be configured to conduct one or more of the actions and/or method steps disclosed herein, such as but not limited to processing the measured values of the attributes to develop the attribute distributions, recalculating control relationships between attributes and process settings, or other operations external to the control system 402.

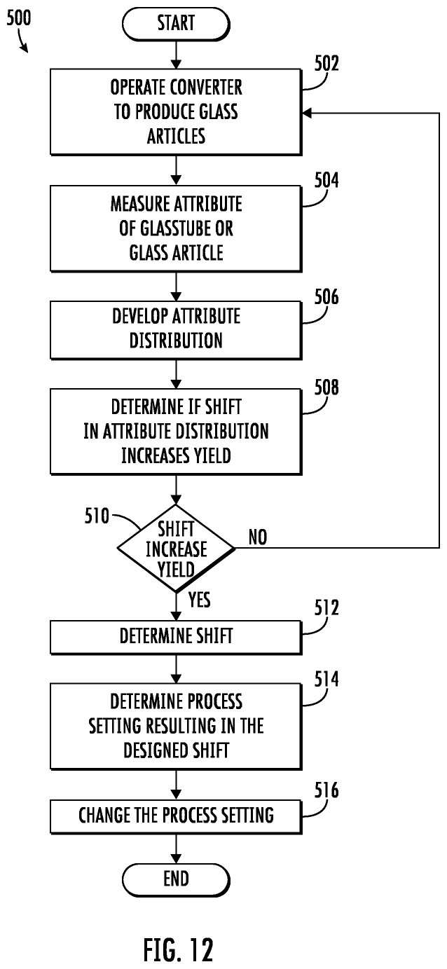

Referring now to FIG. 12, a flowchart of one embodiment of a method 500 for controlling the converter for producing glass articles from glass tubes is depicted. The method 500 may include operating a converter in step 502 to produce the glass articles from the glass tubes, where the converter comprises a plurality of processing stations and operating the converter comprises translating the glass tubes through each of the plurality of processing stations in succession. Operating the converter in step 502 may include any of the process steps disclosed herein for producing the glass articles from glass tubes. The method 500 may further include measuring one or more attributes of the glass articles and/or glass tubes in step 504 during or after conversion. The method 500 may further include developing an attribute distribution from measured values of the attribute in step 506. The method may further include shifting the attribute distribution within a specification range for the attribute (steps 508-516), wherein shifting the attribute distribution increases a yield of the glass articles. Shifting the attribute distribution may include determining if a shift in the attribute distribution increases the yield of glass articles in step 508. Step 510 may be a decision block. In step 510, if the shift does not increase yield or the cost of making the shift is greater than the benefit, then the method may revert back to operating the converter in step 502 and measuring the attributes of the glass tube and/or glass article in step 504. In step 510, if a shift increases yield of the glass articles, the method continues on to determining the shift in the attribute distribution in step 512. After determining the shift in the attribute distribution that increases yield in step 512, the method may further include determining one or more updated process setting in step 514 that correspond to the desired shift in the attribute distribute. The method 500 may further include, in step 516, changing one or more of the process settings to the updated process settings.

The glass articles 103 produced from the glass tubes 102 by the converting process may be pharmaceutical containers, such as but not limited to vials, vacutainers, syringes, ampoules, cartridges, jars, or other glass articles. In embodiments, the glass articles 103 may be glass vials. Referring again to FIG. 10, the glass article 103 may be a glass vial 141. The glass vial 141 may comprise a shoulder 142 and a flange 144 formed at one end of the glass vial 141 and a bottom 146 at the other end the glass vial 141. The glass vial 141 may include a heel 148 that forms a transition between a sidewall 149 and the bottom 146 of the glass vial 141. The flange 144 may include an opening 152 providing access to an internal volume of the glass vial 141. The present methods will be described herein in the context of pharmaceutical glass vials, however, it is understood that the methods disclosed herein may be applied with equal expectation of success with other glass articles, such as syringes, ampoules, cartridges, jars, vacutainers, or other glass articles.

The attributes measured by the measurement device 360 may include attributes of the glass tube 102, attributes of the glass articles 103, or both. The attribute of the glass tube 102, glass article 103, of both may be subject to gradual change over time, a sudden change, or both. The attribute of the glass article 102, the glass article 103, or both may be subject to a specification range defining conforming products. The specification range for each attribute may include an upper specification limit, a lower specification limit, or an upper specification limit and a lower specification limit.

Attributes of the glass tube 102 may include, but are not limited to, outer tube diameter, inner tube diameter, wall thickness, temperature at one or more positions, or other attributes. Attributes of the glass article 103 may comprise one or more feature dimensions, such as, but are not limited to, flange thickness, flange height, neck height, neck outer diameter, neck inner diameter, overall article height, flange inner diameter, flange outer diameter, top height, bottom flange angle, top flange angle, eccentricity, article inside or outside diameter, shoulder thickness, shoulder angle, shoulder radius, other feature dimension, or combinations thereof. The attributes may be different for different types of glass articles. For instance, for syringes, the attributes comprising physical dimensions may include barrel inner or outer diameter, dimensions of the tip, dimensions of the end flange, barrel height, tip height, overall height, or other attributes. Cartridges may have similar attributes to the glass articles, except having an open end opposite the flange instead of a closed bottom. Other glass articles may have one or more other physical attributes that may be measured in the present methods. The attributes of the glass tube 102 and/or glass articles 103 may also include one or more cosmetic attributes.

In embodiments, the glass article 103 may be a glass vial and the attribute may be selected from flange thickness, flange height, flange inner diameter, flange outer diameter, bottom flange angle, top flange angle, neck height, neck outer diameter, neck inner diameter, overall article height, top height, eccentricity, sidewall inside or outside diameter, shoulder thickness, shoulder angle, shoulder radius, other feature dimension, or combinations thereof.

In embodiments, the glass article 103 may be a glass vial and the attribute may be an overall vial height, a flange inner diameter, or both.

The control system 402 may be operable to receive a specification for the glass articles 103 to be produced, where the specification may include a specification value and a specification range for one or more of the attributes of the glass article 103, glass tube 102, or both. For instance, in embodiments, the specification ranges for the attributes of the glass article 103 can include one or more upper specification limits or lower specification limits based on specification values from an international standard for the glass article 103, such as but not limited to ISO 8362-1, “Injection Containers and Accessories-Part 1: Injection Vials Made of Glass Tubing,” Third Edition, 2009 Dec. 15, the entire contents of which are incorporated by reference herein. The following Table 1 provides an example specification from ISO 8362-1 providing dimensions for injection vials made of glass tubing containing a neck finish without blow back (i.e., model A).

TABLE 1
Specification for 2R, 4R, 6R, 8R, 10R, and 15R injection vials with
neck finish without blow back from ISO 8362-1—table 1 (20R, 25R,
30R, overflow capacity, and mass omitted without prejudice).

| Size Designation | 2R | 4R | 6R | 8R | 10R | 15R |
|---|---|---|---|---|---|---|
| Perpendicularity Tolerance (a) | 1 | 1.2 | 1.2 | 1.2 | 1.2 | 1.2 |
| (mm) | | | | | | |
| Outside Diameter of Vial (d₁) | 16 | 16 | 22 | 22 | 24 | 24 |
| (mm) | | | | | | |
| Outside Diameter of Flange (d₂) | 13 | 13 | 20 | 20 | 20 | 20 |
| (mm) | | | | | | |
| Outside Diameter of Neck (d₃) | 10.5 | 10.5 | 16.5 | 16.5 | 16.5 | 16.5 |
| (mm) | | | | | | |
| Inside diameter of Opening (d₄) | 7 | 7 | 12.6 | 12.6 | 12.6 | 12.6 |
| (mm) | | | | | | |
| Total Height of the | 35 | 45 | 40 | 45 | 45 | 60 |
| Vial (h₁) (mm) | | | | | | |
| Height of Sidewall of Vial (h₂) | 22 | 32 | 26 | 31 | 30 | 45 |
| (mm) | | | | | | |
| Combined Height of Neck and | 8 | 8 | 8.5 | 8.5 | 9 | 9 |
| Flange (h₃) (mm) | | | | | | |
| Radius of Shoulder (r₁) (mm) | 2.5 | 2.5 | 3.5 | 3.5 | 4.0 | 4.0 |
| Radius of Heel (r₂) (mm) | 1.5 | 1.5 | 2 | 2 | 2 | 2 |
| Thickness of Sidewall (s₁) (mm) | 1 | 1 | 1 | 1 | 1 | 1 |
| Thickness of Bottom (s₂) (mm) | 0.6 | 0.6 | 0.7 | 0.7 | 0.7 | 0.7 |
| Thickness of Heel (t)(mm) | 0.7 | 0.7 | 0.7 | 0.7 | 0.7 | 0.7 |

As previously discussed, the methods disclosed herein may include measuring one or more of the attributes of the glass tube 102, glass article 103, or both for a plurality of glass tubes 102 and/or glass articles 103. The attributes may be measured using the measurement device 360, which may be disposed in one of the processing stations 106 of the converter 100, coupled to a holder 130 of the converter, or disposed downstream of the converter 100. In embodiments, the methods may comprise measuring one or more attributes of the glass articles 103 after forming one or more features of the glass article 103 at the working end 150 of the glass tube 102. In embodiments, the attribute of the glass article 103 may be measured with the measurement device 360 disposed in a processing station 106 downstream of the forming stations or coupled to a holder 130 of the converter. In embodiments, operating the converter 100 comprises forming one or more features of the glass article 103 at the working end 150 of the glass tube 102 and, after the forming, separating the glass article 103 from the working end 150 of the glass tube 102, and the method may include measuring the attribute of the glass article 103 after the forming the one or more features of the glass article 103 and the separating the glass article 103 from the working end 150 of the glass tube 102.

In embodiments, the method may comprise measuring the attribute of the glass article 103 after conversion to produce the glass article 103 from the glass tube 102, such as after the glass article 103 has been ejected from the converter 100. In embodiments, the method may further include annealing the glass article 103 after discharging or ejecting the glass article 103 from the converter 100, and measuring the attribute of the glass article 103 may be conducted after annealing the glass article 103. In embodiments, the measurement device 360 may be disposed downstream of the annealing process.

The attributes may be measured for a number of glass articles 103 sufficient to produce an attribute distribution that approximates the true distribution of the attribute. The true distribution of the attribute refers to a theoretical attribute distribution that represents an infinite number of measurements of the attribute. The number of glass articles 103 for which the attribute is measured to produce the attribute distribution may be referred to herein as the “lookback window.” In embodiments, the lookback window may include a statistically relevant number of glass articles 103. In embodiments, the method may comprise measuring the attributes for a number of glass articles 103 in the lookback window of greater than or equal to 50, greater than or equal to 60, greater than or equal to 100, or even greater than or equal to 200. In embodiments, the method may comprise measuring the attributes for a number of glass articles 103 of from 50 to 2000, from 50 to 1000, from 50 to 500, from 50 to 200, from 50 to 100, from 60 to 2000, from 60 to 1000, from 60 to 500, from 60 to 200, from 60 to 100, from 100 to 2000, from 100 to 1000, from 100 to 500, from 100 to 200, from 200 to 2000, 200 to 1000, or from 200 to 500 for each lookback window. In embodiments, the number of glass articles for which the attributes may be measured may be greater than 2000.

After measuring, the measured values of the attributes for each of the glass articles 103 may be transmitted to the control system 402. The measured values of the attributes may be saved in the one or more memory modules 406 of the control system 402 or the external computing system 420. The measured values of the attributes may be stored in a relational database on the memory modules 406 of the control system 402 or the external computing system 420. Each of the glass articles 103 may be assigned a unique identifier and the relational database may associate each glass article with the specific holder 130, operating conditions, and process settings for producing the glass article 103 through the unique identifier. The unique identifier and relational database may be part of a part tracking system that may be used to track each of the individual glass articles through the converting process.

As previously discussed, after measuring the attribute for a plurality of glass articles, the methods may include determining the attribute distribution from the measured values of the attribute in the lookback window. The attribute distribution may be produced using statistical methods executed by the control system 402. In embodiments, the control system may upload the measured values of the attribute to the external computing device 420, and the external computing device 420 may produce the attribute distribution from the measured values of the attribute. The attribute distribution may deviate from a normal distribution. In embodiments, the attribute distribution may be a non-symmetric distribution, such as having a heavy tail, being multimodal, or having any other irregular, non-Gaussian distribution shape. In embodiments, the attribute distribution may further include an indication of the specification range of the attribute.

After preparing the attribute distribution, the methods disclosed herein may include determining a shift in the attribute distribution within the specification range that increases the yield of the glass articles. Determining whether a shift in the attribute distribution within the specification range may include comparing the attribute distribution to the specification range and determining whether moving the attribute distribution one way or the other would increase the number of conforming glass articles within the specification range. The step of determining a shift in the attribute within the specification range that increases the yield of the glass articles may be performed by the control system 402 or the external computing device 420. In embodiments, the methods may comprise determining whether a shift in the attribute distribution within a specification range for the attribute increases a yield of the glass articles, and when the shift in the attribute distribution increases the yield of the glass articles, shifting the attribute distribution within the specification range for the attribute. In embodiments, the methods may comprise determining when a shift in the attribute distribution does not increase the yield, and when a shift in the attribute distribution does not increase the yield, maintaining the process settings at a present setpoints.

Determining whether a shift in the attribute distribution within the specification range increases the yield of the glass articles may include performing a series of simulations to determine a shift that increases yield empirically or using first principles or statistical methods to calculate a shift that increases the yield. In embodiments, determining whether a shift in the attribute distribution within the specification range increases the yield of the glass articles may include conducting a series of simulations in which the attribute distribution is numerically shifted about with respect to direction (i.e., either towards the upper specification limit or towards the lower specification limit), magnitude, or both, to produce a plurality of simulated shifts. At each simulated shift, the yield of glass articles is computed. The yield of glass articles refers to the proportion of glass articles that fall within the specification range for the measured attribute relative to the total number of glass articles produced. The simulated shift that results in the greatest yield of the glass articles may be referred to as the best simulation. The best simulation may represent the shift in the attribute distribution within the specification range that increases the yield of the glass articles to the greatest extent.

In embodiments of the methods, determining the shift in the attribute distribution within the specification range that increases the yield of the glass articles may include conducting a plurality of simulations, wherein in each of the plurality of simulations, the attribute distribution is shifted by a different magnitude, direction, or both; determining a best simulation from the plurality of simulations, wherein the best simulation may produce a greatest yield of the glass articles; and setting the magnitude and the direction of the shift in the attribute distribution equal to the magnitude and the direction corresponding to the best simulation. If none of the simulations result in an increase in yield of the glass articles, then the present attribute distribution is the best and the attribute distribution may not be shifted within the specification range. Shifting the attribute distribution may comprise determining a characteristic of the attribute distribution, such as but not limited to a mean, median, maximum value, minimum value, primary peak value, secondary peak value, standard deviation, or other characteristic, and then moving the characteristic of the attribute distribution, which moves the attribution distribution relative to the specification value and specification range of the attribute.

In some instances, a plurality of the shift simulations may result in similar or identical yields of glass articles corresponding to the greatest yield. If multiple shift simulations result in the same or similar yields representing the greatest increases in the yield of glass articles, the best simulation may be the shift simulation that is the most robust to future changes to the attribute distribution, such as but not limited to changes caused by drift in the measured values of the attribute. In embodiments, the best simulation may be the shift simulation for which a further change or drift in the attribute distribution would result in the smallest decrease in yield of conforming glass articles.

In some instances, a plurality of the shift simulations may result in 100% yield of glass articles with respect to the specific attribute. In these cases, the best simulation is the shift simulation that can tolerate the largest offset or change in the attribute distribution and still maintain 100% yield of the glass articles. In embodiments, when two or more of the shift simulations result in 100% yield of the glass articles, the best simulation may comprise a shift simulation that accommodates the largest offset of the attribute distribution while still maintaining 100% yield of the glass articles. In embodiments, two or more of the plurality of simulations may result in 100% yield of the glass articles, and the best simulation may be a simulation in which a smallest absolute value of a difference between the measured values of the attribute distribution and an upper limit or a lower limit of the specification range is greatest and the yield of the glass articles is 100%.

In some instances, the direction of future changes in the position of the attribute distribution relative to the specification range may be known. For instance, tool wear and/or actuator wear may be expected to result in drift of the attribute distribution relative to the specification range in an expected direction. Known drift may be accounted for by shifting the attribute distribution closer to the upper specification limit or the lower specification limit, depending on the direction of the expected drift in the attribute distribution, while still maintaining 100% yield of the glass articles. In embodiments, two or more of the plurality of simulations may result in 100% yield of the glass articles, the attribute may be known or expected to drift in a specific direction, which may be towards the upper specification limit or the lower specification limit of the specification range; and the best simulation may comprise a simulation that results in 100% yield of the glass articles and provides a greatest absolute value of a difference between either the upper specification limit or the lower specification limit and a closest measured attribute value to the upper specification limit or the lower specification limit, respectively, in the specific direction of the expected drift. The closest measured attribute value is the measure attribute value in the attribute distribution that is closest to the specification limit in the direction of the expected drift. Thus, the average or mean of the attribute distribution may be shifted farther away from the specification limit in the expected direction of drift, which may allow the attribute distribution to drift within the specification range with 100% yield for the longest period of time before having to shift the attribute distribution again.

Instead of empirically determining the shift in the attribute distribution through conducting a plurality of simulations, in embodiments, determining whether the shift in the attribute distribution increases the yield of the glass articles may include analysis and/or calculation based on first principles, statistical methods, or both without performing a series of simulations. In embodiments, determining the shift in the attribute distribution within the specification range that increases the yield of the glass articles may comprise analyzing the attribute distribution to determine a property, a relationship, or both that is characteristic of the attribute distribution and calculating the shift in the attribution distribution within the specification range that increases the yield of the glass articles from the property, the relationship, or both that is characteristic of the attribute distribution. Analyzing the attribute distribution to determine a property, a relationship, or both that is characteristic of the attribute distribution comprises applying first principles, statistical methods, or both to the attribute distribution.

In some instances, the benefits of shifting the attribute distribution within the specification range to increase yield may be outweighed by the costs of making the shift. In some cases, the benefit of increasing the yield of the glass articles may be small and may not overcome the costs associated with applying the shift. The costs may include the undesirable consequences of drawing an operator's attention away from other matters to attend to shifting the attribute distribution. Thus, with human operators in the loop, the shift in the attribute distribution within the specification range may be recommended only if the forecasted benefit from the increase in yield is greater than a threshold benefit, below which the costs outweigh the benefits. Costs can also be associated with effects of the shift in the attribute distribution on downstream processes or other attributes, such as a shift in the attribute distribution causing a change in another measured attribute that must then be analyzed.

In embodiments, after determining the shift in the attribute distribution within the specification range that increases the yield of the glass articles, the method may further include determining whether the benefits of shifting the attribute distribution within the specification range to increase yield outweighs the costs associated with making the shift. In embodiments, determining the shift in the attribute distribution within the specification range may further comprise determining if the benefits of shifting the attribute distribution within the specification range is greater than the costs of shifting the attribute distribution; when the benefit of shifting the attribute distribution is greater than the cost, proceeding with shifting the attribute distribution, such as by adjusting at least one process setting to shift the attribute distribution with the specification range; and when the benefit of shifting the attribute distribution is less than the expected costs, maintaining not shifting the attribute distribution and instead maintaining process settings at the previous values.

When it is determined that shifting the attribute increases the yield and the benefits of doing so outweigh the costs, then the methods disclosed herein may further include applying the shift in the attribute distribution. Shifting the attribute distribution may comprise adjusting at least one process setting, where adjusting the at least one process setting causes the attribute distribution to shift within the specification range. Adjusting the at least one process setting may include determining an updated setpoint of the at least one process setting and adjusting the at least one process setting to the updated setpoint. In embodiments, shifting the attribute distribution may include adjusting a plurality of process settings, such as be determining updated setpoints for each of the plurality of process settings and then adjusting each of the plurality of process setting to the updated process settings.

The updated setpoints for the process settings may be determined from the magnitude and direction of the shift in the attribute distribution and a control relationship between the process setting and the attribute. In embodiments, determining the updated setpoint of the at least one process setting may include determining the shift in the attribute distribution within the specification range that increases the yield of the glass articles and calculating the updated setpoint of the at least one process setting from the magnitude and the direction of the shift in the attribute distribution and a control relationship between the at least one process setting and the attribute. The updated setpoints for the process settings may be determined using one or more control methodologies, such as but not limited to proportional-integral-derivative (PID) control method, a lead/lag control method, a model predictive control methodology, or other control methodology.

The process settings may be any of the process settings associated with the control devices that, when operated, have an effect on the attribute being measured. Process settings may include, but are not limited to, overall part rate, a holder 130 rotation rate, burner positions in one or a plurality of heating stations 202, burner contacting time in the heating stations 202, burner heat outputs in one or a plurality of heating stations 202, positions of forming tools 324 in one or a plurality of the forming stations 204, contact timing (i.e., total contact time, contact sequence, or both) between forming tools 324 and the glass tube 102 in one or more forming stations 204, contact sequence of the forming tools 324 with the glass tube 102, position of the mechanical stopper 330 in a tube length drop station 220 or forming station 204, other operating parameter, or combinations thereof. Referring to FIG. 3, the burner positions of the burners 302 in the heating stations 202 may include vertical position (e.g., +/−Z direction of the coordinate axis in FIG. 3), horizontal position (e.g. position in the X-Y plane of the coordinate axis in FIG. 3), or combinations thereof of the burners 302 relative to the glass tube 102, as controlled by burner positioner 318. Burner heat outputs of the burners 302 in the heating stations 202 may include positions of one or more of the fuel gas control valve 310, oxygen control valve 312, air control valve 314, or combinations of these, which may control the burner heat output of the burners 302.

Referring now to FIGS. 4 and 5, the forming tool positions of the forming tools 324 in the forming stations 204 may include vertical position (e.g., +/−Z direction of the coordinate axis in FIGS. 4 and 5), horizontal position (e.g. position in the X-Y plane of the coordinate axis in FIGS. 4 and 5), or combinations thereof of the forming tools 324 relative to the glass tube 102, as controlled by the outer forming tool actuators 326, inner forming tool actuator 328, or combinations thereof. The horizontal positioning of the forming tools 324 may refer to the horizontal position of the forming tools 324 in the engagement position. When in the engagement position, the horizontal positioning of the forming tools 324 may determine the pressure of the forming tools 324 against the glass tube 102. Contact timing between the forming tools 324 and the glass tube 102 may be controlled by controlling actuation operation of the forming tool actuators 326 to adjust the timing of moving the forming tools 324 into and out of engagement with the glass tube 102 in the forming stations 204. As previously discussed, the contact timing can be adjusted to control the total contact time, contact sequence, or both in a forming station 204.

Referring now to FIG. 6, the process setting may be a position of the mechanical stopper 330 in a tube length drop station 220 or in a forming station 204, where the position of the mechanical stopper 330 is controlled by the stopper positioner 332. Other process settings relating to separating stations 206, cooling stations 210, piercing stations 212, bottom forming stations, polishing stations, tube loading stations, or other processing stations may also be contemplated in shifting the attribute distribution.

In embodiments, shifting the attribute distribution may include modifying a single process setting. For instance, in embodiments, the attribute may be a vial height of a glass vial and process setting may be a position of the mechanical stopper 330 in the tube length drop station 220 or forming station 204 of the converter 100. In this case, only a single process setting is needed to shift the attribute distribution. In embodiments, shifting the attribute distribution may include changing a plurality of process settings. For instance, in embodiments, the glass article may be a glass vial and the attribute may be an inner diameter of the flange 144 of the glass vial 141, where a plurality of process settings effect the inner diameter of the flange 144. In embodiments, the process settings for shifting the attribute distribution relating to the inner diameter of the flange 144 may include, but are not limited to, a vertical position of the inner forming tool, the horizontal position of the inner forming tool, the vertical position of the outer forming tool(s), the horizontal position of the outer forming tool(s), the contact time of the forming tools with the glass tube, the contact sequence of the forming tools with the glass article, rotational speed of the holder, heating rate of the heating elements in heating stations upstream of the forming station, or other process settings.

The control relationship may be developed from first principles or empirically using statistical methods. In embodiments, the control relationship between the attribute and the process setting or plurality of process settings may be developed through a design of experiments process. Further information on developing control relationships for a converter can be found in co-pending U.S. application Ser. No. 17/746,396, filed on May 17, 2022, and entitled “CONVERTER SYSTEMS AND METHODS FOR CONTROLLING OPERATION OF GLASS TUBE CONVERTING PROCESSES,” the entire contents of which are incorporated by reference herein.

Once the updated setpoint for each of the process settings is determined from the control relationship, the methods disclosed herein may include changing each of the process settings to the updated setpoint for that process setting. In embodiments, the system 400 may be automatic, and the control system 402 may automatically change the process settings to the updated process settings. Referring to FIG. 11, in embodiments, the system 400 may be partially automatic, and updating the process settings to the updated setpoints may include displaying the updated setpoints for the process settings on the display 430 of the control system 402. In response to display of the updated setpoints for the process settings, an operator may change the process settings to the updated setpoints manually or accomplish changing the process settings to the updated setpoints with the control system 402 through a user interface device, such as the graphical user interface 432 or other user input device.

In embodiments, the control relationship between the process settings and the attribute may be empirically well established. In such cases, if the control device is under automatic control, the shift can be applied directly by the control system 402 based on the updated setpoints of the process settings calculated from the control relationship. In situations in which there is uncertainty in the control relationship, such as with empirical control relationships considering and incorporating a plurality of process settings, the shift can be discounted by a factor. In other words, the updated setpoints of the process settings can be modified so that the change in the process setting is decreased in order to reduce undesirable control responses, such as overshoot, oscillation, or runaway process control. The factors may be developed based on simulation, trial and error, operator intuition and experience, or other considerations. This strategy of discounting the shift by a factor may be equivalent to tuning an integral control algorithm.

Following changing the process settings to the updated setpoints, the methods disclosed herein may further include verifying the shift of the attribute distribution within the specification range. Verifying the shift of the attribute distribution within the specification range may include measuring values of the attribute over a lookback window comprising a number of glass articles sufficient to generate an attribute distribution that approximates the true distribution in the measured attributes, preparing a post-shift attribute distribution from the measured values, and comparing the post-shift attribute distribution to a predicted attribute distribution. The predicted attribute distribution is the attribute distribution expected from applying the shift and may be the attribute distribution corresponding to the best simulation. In embodiments, the predicted attribute distribution may be calculated by applying the shift to the initial attribute distribution developed from the measured values of the attribute before changing the process settings. When the post-shift attribute distribution and the predicted attribute distribution are congruent, then the shift is maintained. The post-shift attribute distribution and the predicted attribute distribution may be considered to be congruent when the yield percentages resulting from each differ by less than or equal to 1%, less than or equal to 0.5%, or even less than or equal to 0.1%. When the post-shift attribute distribution is offset from the predicted attribute distribution, then the difference can be further compensated for through additional control action. Whether to take additional action in response to differences between the predicted attribute distribution and the post-shift attribute distribution may take into account balancing of various factors, such as but not limited to the level of automated control or the costs and benefits of making an additional change.

In embodiments, the difference between the post-shift attribute distribution and the predicted attribute distribution can be remediated by conducting feedback control to adjust the process settings until the post-shift attribute distribution is congruent with the predicted attribute distribution. In embodiments, the methods disclosed herein may include after adjusting the process settings, measuring the attribute of the glass articles; developing the post-shift attribute distribution based on the measured attributes of the glass articles after adjusting the process settings; comparing the second attribute distribution to a predicted attribute distribution, where the predicted attribute distribution is calculated by applying the shift to the initial attribute distribution; and further adjusting the process settings based on the comparison of the post-shift attribute distribution and the predicted attribute distribution. In embodiments, the process of measuring attributes, producing the post-shift attribute distribution, comparing the post-shift attribute distribution to the predicted attribute distribution, and adjusting the process settings may be repeated a plurality of times until the post-shift attribute distribution is congruent with the predicted attribute distribution. In embodiments, comparing the post-shift attribute distribution to the predicted attribute distribution may comprise determining a statistical property of the post-shift attribute distribution and the predicted attribute distribution; calculating an error between the statistical property of the post-shift attribute distribution and the statistical property of the predicted attribute distribution; and shifting the post-shift attribute distribution based on the calculated error. In embodiments, shifting the post-shift attribute distribution based on the error may comprise calculating adjustments to the process settings from the calculated error.

In some instances, differences between the post-shift attribute distribution and the predicted attribute distribution may result from discounting the process settings by a factor to reduce undesired control responses (e.g., adjusting the process settings to the updated process settings in increments to avoid control responses such as overshoot, oscillation, divergent instability, or other undesirable control responses). In other cases, the differences between the post-shift attribute distribution and the predicted attribute distribution may be the result of changes in the relationship between the process settings and the measured attributes, such as gradual drift of process settings over time (e.g., drift resulting from wear) or step changes in the relationship between process settings and measured attributes (e.g., resulting from component replacement or other maintenance activities, changes in incoming fuel gas composition, changes in ambient environment, etc.).

When gradual or sudden changes to the relationship between the process settings and measured attributes occur, the control relationship used to determine the process settings for accomplishing a particular shift in the attribute distribution may not be accurate. In embodiments, the methods herein may include developing an updated control relationship between the at least one process setting and the attribute. Developing the updated control relationship can include calculating the updated control relationship based on first principles (e.g., scientific principles, mathematical principles, etc.) or empirically using statistical methods or a design of experiments process. Further information on conducting a design of experiments analysis to develop control relationships for a converter can be found in co-pending U.S. application Ser. No. 17/746,396, previously incorporated by reference herein. In embodiments, developing the updated control relationship may include calibrating one or more control devices of the converter.

The control strategies of the methods herein can be applied to the entire attribute distribution. Additionally or alternatively, greater refinement in the control can be achieved by compensating for known causes of abnormalities in the attribute distribution. In some cases, the causes of certain deviations in the measured attribute from glass article to glass article may be known with a high degree of certainty, such as in the case of chuck-to-chuck variations. In these embodiments, the control response may be tailored to account for known sources of deviations in the measured values of the attribute of the glass article. In embodiments, adjusting the at least one process setting may include determining one or more causes of deviations of the attribute distribution outside of the specification range and modifying an adjustment to the setpoint of the at least one process setting controlled variable depending on the one or more causes of the deviation of the attribute distribution.

As an example, known deviations in the measured attribute can occur due to the differences between each of the plurality of holders, and the chucks incorporated therein, which are used to hold and rotate the glass tube during converting. Greater refinement in the control response can be achieved by making separate controllers as a function of the source of deviations in the measured attributes, such as but not limited to the vial height. For instance, in embodiments, after separation of the glass article from the working end of the glass tube, the specific secondary holder 132 (e.g., holders and corresponding chucks for the secondary circuit 118 of secondary processing stations 112, see FIG. 2) may be known to cause a large percentage of the overall variations in the total height of the glass article (e.g., vial height of a glass vial). In these embodiments, separate control decisions may be applied to the process settings depending on the secondary holder 132 that will processes the glass article. In particular, separate attribute distributions may be developed for each holder 130, and the separate attribute distributions may be used to develop a control response for each of the holders 130. The specific secondary holder 132 for each glass article may be tracked using the part tracking system that was previously discussed herein. The part tracking system comprising the unique identifier and relational database may keep track of the holder 130 and secondary holder 132 used to make each glass article 103, and relate this information to the measured attributes of the glass article. In this way, the controller can be partitioned in some cases by assignable cause and thereby achieve tighter overall height control. For glass articles that are glass vials, variations in the measured vial flange inner diameter can also be attributed, in part, to the specific holder 130 in the main circuit 116 of the converter. Thus, for the flange inner diameter of glass vials, greater refinement can be achieved by adjusting the control response based on the holder 130 of the main circuit 116 used to produce the glass vials. Other measured attributes may also experience holder-to-holder variation.

In embodiments, the converter comprises a plurality of holders and operating the converter may include securing a glass tube in two or more of the plurality of holders and translating each of the plurality of holders through the plurality of processing stations in succession. The methods disclosed herein may comprise developing an attribute distribution for each of the plurality of holders from the measured values of the attribute, and shifting the attribute distribution for each of the plurality of holders within a specification range for the attribute, wherein shifting the attribute distribution for each of the plurality of holders increases a yield of the glass articles. The attribute distribution for each of the plurality of holders may be a holder-specific attribute distribution and may be developed from measured values of the attributes from glass articles associated with the specific holder through the part tracking system. In embodiments, shifting the attribute distribution for each of the plurality of holders may comprise determining an updated process setting or set of updated process settings for each of the holders 130, secondary holders 132, or both. As each holder 130 or secondary holder 132 is translated into the specific processing station 106, the process settings are changed to the updated process setting or set of updated process settings for that specific holder 130 or secondary holder 132. The updated process settings for each holder 130, secondary holder 132, or both may be determined from the shift in the attribute distribution and the control relationship for each specific holder 130, secondary holder 132, or both. In embodiments, a control relationship may be developed for each individual one of the holders, secondary holders, or both.

In embodiments, the glass article may be a glass vial and the attribute may be the overall vial height. During operation, the flange, neck, and shoulder features are formed at the working end of the glass tube through operation of one or more processing stations of the converter. Following formation of the flange, the glass tube may be dropped in a tube length drop operation, which may be part of a forming station or may be incorporated into a separate tube length drop station, as previously discussed. After the tube drop operation, the glass tube is heated and separated at a distance from the working end of the glass tube to produce a partially finished glass article, which is then transferred to the secondary circuit for bottom forming and polishing. The glass vial may then be ejected from the converter and annealed.

The methods may include measuring the overall vial height of the glass vial. The overall vial height may be measured after annealing the glass vials, before annealing the glass vials, or on the converter following bottom forming. Each of the measured values may be attributed to the specific glass vial and the specific holder and secondary holder used to make each specific glass vial. The methods may include developing a distribution of the overall vial height for each of the holders, secondary holders, or both. The methods may further include shifting the distribution of the overall vial height for each of the individual holders, secondary holders, or both by determining updated process settings for each individual holder or secondary holder from the shift in the attribute distribution and control relations for each individual holder or secondary holder. For the tube length drop operation, the relationship between the vial height and the position of the mechanical stopper may be about 1:1.

In embodiments, the glass article may be a glass vial and the measured attribute may be the flange inner diameter of the glass vial. For the flange inner diameter, the process settings may include inner forming tool positon, outer forming tool position, forming tool contact time, forming tool contact sequence, preheating duration, glass temperature, other process setting effecting flange inner diameter, or combinations of these. In some cases, the flange inner diameter may be influenced by a number of different process settings.

In embodiments, the methods disclosed herein for controlling the converting process may be repeated throughout operation of the converter. A timeframe between iterations of the control methods disclosed herein may be sufficient for the previous change in the updated process settings to produce the shifted attribute distribution, as recognized by the measurement device used to measure the attribute. The timeframe between iterations of the control method may depend on the location of the measurement device relative to the location of the process settings controlled by the method. For instances, when the measurement device 360 is disposed downstream of the annealing process, the glass articles may take up to 30 minutes to traverse the production line from the processing station at which the process setting is located to the measurement device. Once the change in the attribute distribution is manifest at the measurement device 360, the control method can be repeated, starting with measuring the attribute for a number of glass articles sufficient to produce the attribute distribution that is representative of the true distribution of the measured attribute. In embodiments, the control system may be configured to disallow any adjustments to the process settings after a predetermined period of time, which may include the timeframe for the glass articles to traverse the production line from the processing station having the process settings to the measurement device, the time needed to measure the attributes for a number of glass article sufficient to get a representative distribution, or both. Disallowing changes to the process settings during these times may provide the system dynamics time for the process settings to manifest in the finished glass articles before developing any further control response.

In any of the methods disclosed herein, the converter 100 may include a plurality of holders 130 and the methods disclosed herein may include securing one of a plurality of the glass tubes 102 in each of the plurality of holders 130 and passing each of the plurality of holders 130 and the glass tubes 102 disposed therein through the plurality of processing stations 106. In any of the methods disclosed herein, each of the plurality of processing stations 106 of the converter 100 may be in a fixed position and the methods may include indexing the glass tube 102 through each of the processing stations 106 sequentially in succession. Alternatively, in embodiments, in any of the methods disclosed herein, the converter 100 may be a continuous converter, and the methods may include passing the glass tube continuously through the plurality of processing stations 106, where each of the plurality of processing stations 106 may move in coordination with translation of the glass tube 102 during the active time.

Referring again to FIG. 11, in embodiments, the system 400 may include a distributed computing environment comprising the converter 100 and the control system 402, a network 410, and one or more external computing devices 420. The control system 402 may communicate with the external computing devices 420 through the network 410. One or more steps in the methods disclosed herein may be accomplished using the external computing devices 420 alone or in combination with the control system 402. Although shown in FIG. 11 as being directly and communicatively coupled to the converter 100, it is understood that the control system 402 may additionally communicate with the converter 100 through the network 410. The network 410 may be a wired or wireless network. In embodiments, the network 410 may be a cloud network. The network may be any other type of network, such as but not limited to a LAN or WAN.

Embodiments of the disclosure may be embodied in hardware and/or in software (including firmware, resident software, micro-code, etc.). The control system 402 of the converter 100 and/or other controllers on the converter 100 may include at least one processor and the computer-readable storage medium (i.e., memory module) as previously described in this specification. The control system 402 may be communicatively coupled to one or more system components (e.g., converter 100, heating element positioner 318, burner control valves, oxygen control valves 312, air control valves 314, forming tool actuators 326, 328, stopper positioner 332, chuck 334, measurement device 360, converter drive system, etc.) via any wired or wireless communication pathway. A computer-usable or the computer-readable storage medium or memory module 406 may be any medium that can contain, store, communicate, propagate, or transport the program for use by or in connection with the instruction execution system, apparatus, or device.

The computer-usable or computer-readable storage medium or memory module 406 may be, for example but not limited to, an electronic, magnetic, optical, electromagnetic, infrared, or semiconductor system, apparatus, device, or propagation medium. More specific examples (a non-exhaustive list) of the computer-readable storage medium or memory module 406 would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable storage medium or memory module 406 could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The computer-readable storage medium or memory module 406 may include the machine readable and executable instructions 408 for carrying out operations of the present disclosure. Any of the method steps herein may be carried out through execution of the machine readable and executable instructions 408 by the processors 404 of the control system 402. The machine readable and executable instructions 408 may include computer program code that may be written in a high-level programming language, such as C or C++, for development convenience. In addition, computer program code for carrying out operations of the present disclosure may also be written in other programming languages, such as, but not limited to, interpreted languages. Some modules or routines may be written in assembly language or even micro-code to enhance performance and/or memory usage. However, software embodiments of the present disclosure do not depend on implementation with a particular programming language. It will be further appreciated that the functionality of any or all of the program modules may also be implemented using discrete hardware components, one or more application specific integrated circuits (ASICs), or a programmed digital signal processor or microcontroller.

### EXAMPLES

The following examples illustrate the operation of the disclosed systems and methods for producing a plurality of glass articles from glass tube in a converter. The following examples are not intended to limit the scope of the present disclosure.

### Example 1: Vial Height Control with Control System

The following Example 1 illustrates operation of a vial height control system utilizing the control methods disclosed herein for controlling vial height of glass vials. For Example 1, the glass tubes were converted into glass vials using a converter. The converter used was a Vial Forming Machine Model RP18 with Automatic Tube Feeder manufactured by AMBEG Dr. J. Dichter GmbH, which included eighteen processing stations in the main circuit. The converter included a tube drop station having a mechanical stopper and stopper positioner for repositioning the glass tube so that separation of the glass vial from the glass tube and bottom finishing results the final vial height of the glass vials. The adjustment to the stopper positioner for adjusting the position of the mechanical stiller was calibrated so that a change in the position of the mechanical stopper correlated one to one to the resulting change in the final vial height of the glass vials.

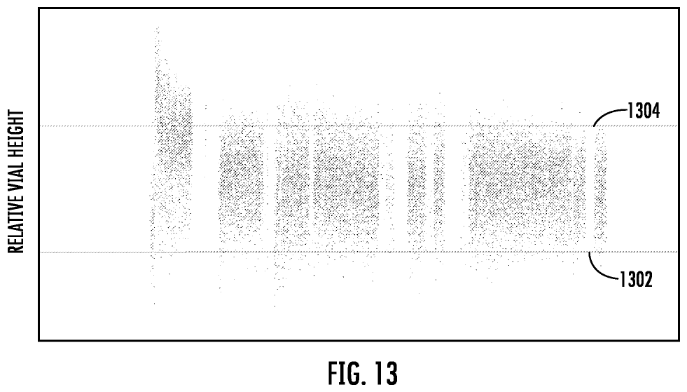

Following ejection from the converter, the glass vials were annealed. Measurement of the final vial height attribute was conducted after the annealing process. The time between the tube drop station and the measurement of the final vial height after annealing was about 30 minutes. During operation of the converter, a number of glass vials were measured for final vial height. The measured values of the final vial height were then used to produce an attribute distribution for the final vial height. The attribute distribution was compared to the specification limits for the final vial height (e.g., lower specification limit 1302 and upper specification limit 1304 in FIG. 13). A shift in the attribute distribution was determined to maximize yield by developing a plurality of shift simulations. The best simulation and the control relationship between final vial height and the position of the mechanical stopper (i.e., 1:1 relationship between vial height and position of the stopper) were used to determine the process setting, which was the position of the mechanical stopper. For Example 1, the change to the position of the mechanical stopper was discounted by 50% for robustness. The discount of 50% was selected arbitrarily and enables the control response to be better illustrated.

Referring now to FIG. 3, data comprising relative final vial height as a function of time for Example 1 is graphically depicted. As described above, the control system for controlling vial height sought the proper adjustment to the final vial height to increase the yield. As shown in FIG. 3, after making an adjustment, a wait time of 30 minutes was experienced until the glass vials formed under the updated process settings begin to reach the measurement system. Therefore, a delay of 30 minutes plus an amount of time necessary for measuring a sufficient number of glass vials was established between adjustments to the stopper positioner.

In FIG. 13, the data indicates numerous starts and stops of the converter, which were due to testing and problem fixes unrelated to operation of the vial height control system. Despite the starts and stops, FIG. 13 clearly shows that the vial height control system based on shifting the attribute distribution was successful at adjusting the final vial height within the specification ranges to maximize yield and maintained the final vial height within the specification range. Thus, FIG. 13 shows that the control methods disclosed herein are effective to control final vial height of the glass vials to provide greater yield.

### Example 2: Flange Inner Diameter Control with Control System

In Example 2, a flange inner diameter control system utilizing the control methods disclosed herein was implemented to control the flange inner diameter of the glass vials. For Example 2, the glass vials were produced using the converter in Example 1. The glass vials were annealed after ejection from the converter, and the flange inner diameter was measured using the measurement device disposed downstream of the annealing process. The flange inner diameter control system of Example 2 included a manual user in the control loop. In particular, the flange inner diameter control system of Example 2 was configured to measure the flange inner diameter of the plurality of glass vials and produce the attribute distribution from the measured values of the flange inner diameter, determine a shift in the attribute distribution that produces the greatest yield, and determine the updated process settings corresponding to the shift in the attribute distribution. The flange inner diameter control system of Example 2 was further operable to display the attribute distribution, the proposed shift in the attribute distribution, and the proposed updated process settings on a display. The adjustments to the process settings were then observed by the manual user, and the manual user then executed the change to the process settings on the converter.

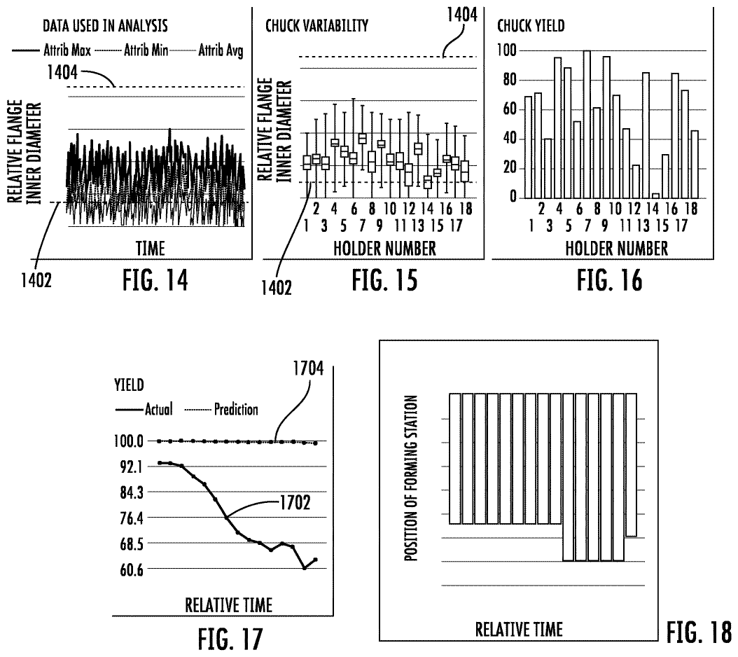

For the flange inner diameter, the process settings effecting flange inner diameter are related to the addition or subtraction of glass into the forming station for forming the flange. The addition or subtraction of glass into the forming station is directly related to the servo-adjusted height of the forming station relative to the working end of the glass tube. In particular, the process settings include the positions of one or more of the forming tool positioners in the forming station, which positioners control the vertical position (e.g., height) of the forming tools in the forming station relative to the working end of the glass tubes. Referring to FIG. 14, the flange inner diameter has a lower specification limit 1402 and an upper specification limit 1404. The flange inner diameter is required to have a maximum inner diameter measurement and a minimum inner diameter measurement between the lower specification limit 1402 and the upper specification limit 1404.

Referring again to FIG. 14, a trace of the measured values of the flange inner diameter are graphically depicted. The trace in FIG. 14 includes the maximum flange inner diameter, minimum inner diameter, and average inner diameter for each of the plurality of glass vials measured. Referring now to FIG. 15, the average positions of the forming tools relative to the working end of the glass tubes as a function of number of the holder in the main circuit, in box plot form, are graphically depicted. FIG. 16 shows the percentage yield by the number of the holder in the main circuit. As shown in FIGS. 14 and 15, the distribution center of the flange inner diameter is well correlated with the number of the holder of the main circuit, since any errors or variation in the position of each holder are also errors in the positions of the burners and forming tools with respect to the working end of the glass tube in each processing station. FIGS. 14 and 15 may be displayed on the display and may be used to identify outlier holders that may be in need of maintenance, such as servicing or adjustment. Knowing the holder-to-holder variation may be used to produce a different adjustment of the process settings for each of the holders.

Referring now to FIG. 17, the actual historic yield 1702 as a function of time (x-axis) as well as the predicted yield 1704 that could be achieved by adjustment of the process settings in response to a shift in the attribute distribution are graphically depicted for Example 2. As shown in FIG. 17, without adjustment, the actual historic yield 1702 decreases over time. The predicted yield 1704 indicated that making adjustments to the process settings based on shifting the attribute distribution can increase the yield of the glass vials with respect to the flange inner diameter to at or near 100%.

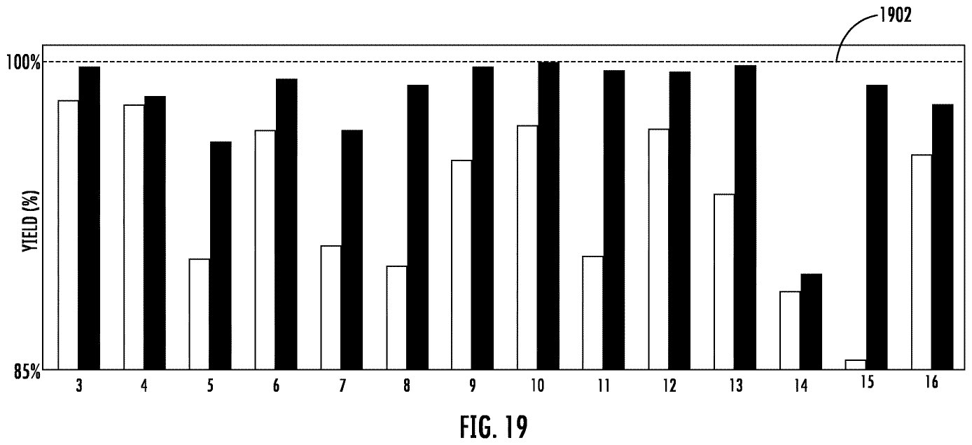

The control system was configured to produce and display a recommended adjustment to the process settings (i.e., position of the forming tools relative to the working end of the glass tube) to increase the yield. Referring now to FIG. 18, history of the recommended adjustments to the process settings as a function of time for Example 2 is graphically depicted. Based on the data in FIG. 18, the control system recommended an adjustment in the position of the forming tools in the forming station of about 120 μm. As shown in FIG. 18, the recommendation for the adjustment to the process setting is fairly consistent, ranging from about −105 μm to about −140 μm over an hour of converter run time. Note that even if the yield is 100%, there can still be a recommended adjustment since if 100% is achievable, then the best attribute shift becomes that which maximizes the amount of shift that can occur before the yield begins to drop below 100%. This improves process robustness against further future changes or drift in the measured values of the attribute.

### Examples 3-16

In examples 3-16, the control strategy described in Example 2 was used to make manual adjustments to the forming tool positions for 14 different run time trials across 6 different converter production lines for making glass vials. The measurement of the flange inner diameter, development of the attribute distribution, determination of the best attribute shift to increase yield, and calculation of updated process settings to accomplish the shift in the attribute distribution were performed by the control system as described in Example 2 and then displayed on a display. For each of Examples 3-16, the updated process settings were implemented by a human operator. It is noted that the adjustment was made only when the control system indicated there was an opportunity for a yield improvement by shifting the attribute distribution. The yield of glass vials with respect to flange inner diameter was determined 1 hour before the change in process settings and 1 hour after the change in process settings. Referring now to FIG. 19, the yield 1 hour before and 1 hour after the change in process settings for each of Examples 3-16 is graphically depicted. For each of Examples 3-16 in FIG. 19, the bar on the left represents the yield 1 hour before the process setting change and the bar on the right represents the yield 1 hour after the process setting change. Reference number 1902 indicates 100% yield. On average over Examples 3-16, the yield improvement resulting from the change in process settings was 4.8%.

While various embodiments of the converter and system and methods for providing feedback control of a converter for producing a plurality of glass articles from glass tubes have been described herein, it should be understood that it is contemplated that each of these embodiments and techniques may be used separately or in conjunction with one or more embodiments and techniques.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method for controlling a converter for producing glass vials from glass tubes, wherein the converter comprises a plurality of holders; the method comprising:
securing a glass tube in two or more of the plurality of holders;
operating the converter to produce the glass vials from the glass tubes, where the converter comprises a plurality of processing stations and operating the converter comprises translating the glass tubes through each of the plurality of processing stations in succession to form one or more features of the glass vial at a working end of the glass tube and, after the forming, separating the glass vials from the working end of the glass tube:
annealing the glass vials after separation;
measuring an attribute of the glass vials after the annealing where the attribute is subject to gradual change over time, sudden change, or both, wherein the attribute is selected from a vial height, a stopper height in a tube drop station of the converter, an inner diameter of a flange, an outer diameter of the flange, a thickness of the flange, a height of the flange, a radius of a shoulder, a height of the shoulder, an outer diameter of a neck, or combinations thereof;
developing an attribute distribution for each of the plurality of holders from the measured values of the attribute of the attribute;
determining whether a shift in the attribute distribution within a specification range for the attribute increases a yield of the wherein shifting the attribute distribution increases a yield of the glass vials; and
shifting the attribute distribution for each of the plurality of holders within a specification range for the attribute, wherein shifting the attribute distribution increases a yield of the glass articles.

2. The method of claim 1, wherein shifting the attribute distribution comprises adjusting at least one process setting.

3. The method of claim 2, wherein adjusting the at least one process setting comprises determining an updated setpoint of the at least one process setting and adjusting the at least one process setting to the updated setpoint.

4. The method of claim 3, wherein determining the updated setpoint of the at least one process setting comprises:
determining a shift in the attribute distribution within the specification range that increases the yield of the glass articles; and
calculating the updated setpoint of the at least one process setting from a magnitude and a direction of the shift in the attribute distribution and a control relationship between the at least one process setting and the attribute.

5. The method of claim 4, wherein determining the shift in the attribute distribution within the specification range that increases the yield of the glass articles comprises:
conducting a plurality of simulations, wherein in each of the plurality of simulations, the attribute distribution is shifted by a different magnitude, direction, or both;
determining a best simulation from the plurality of simulations, wherein the best simulation produces a greatest yield of the glass articles; and
setting the magnitude and the direction of the shift in the attribute distribution equal to the magnitude and the direction corresponding to the best simulation.

6. The method of claim 5, wherein two or more of the plurality of simulations result in 100% yield of the glass articles, and the best simulation comprises a simulation in which a smallest absolute value of a difference between the measured values of the attribute distribution and an upper limit or a lower limit of the specification range is greatest and the yield of the glass articles is 100%.

7. The method of claim 5, wherein:
two or more of the plurality of simulations result in 100% yield of the glass articles;
the attribute is known to drift in a direction towards an upper limit or a lower limit of the specification range; and
the best simulation comprises a simulation that results in 100% yield of the glass articles and provides a greatest absolute value of a difference between either the upper limit or the lower limit and a closest measured value to the upper limit or the lower limit, respectively.

8. The method of claim 5, wherein determining the shift in the attribute distribution within the specification range comprises:
determining if a benefit of shifting the attribute distribution within the specification range is greater than a cost of shifting the attribute distribution;
when the benefit of shifting the attribute distribution is greater than the cost, adjusting the at least one process setting to shift the attribute distribution with the specification range; and
when the benefit of shifting the attribute distribution is less than the cost, maintaining the at least one process setting.

9. The method of claim 4, wherein determining the shift in the attribute distribution within the specification range that increases the yield of the glass articles comprises:
analyzing the attribute distribution to determine a property, a relationship, or both that is characteristic of the attribute distribution; and
calculating the shift in the attribution distribution within the specification range that increases the yield of the glass articles from the property, the relationship, or both that is characteristic of the attribute distribution.

10. The method of claim 9, wherein analysing the attribute distribution to determine a property, a relationship, or both that is characteristic of the attribute distribution comprises applying first principles, statistical methods, or both to the attribute distribution.

11. The method of claim 4, further comprising:
after adjusting the at least one process setting, measuring the attribute of the glass articles;
developing a post-shift attribute distribution based on the measured attributes of the glass articles after adjusting the at least one process setting;
comparing the post-shift attribute distribution to a predicted attribute distribution, where the predicted attribute distribution is calculated by applying the shift to the attribute distribution produced prior to adjusting the at least one process setting; and
further adjusting the at least one process setting based on the comparison of the post-shift attribute distribution and the predicted attribute distribution.

12. The method of claim 11, wherein comparing the post-shift attribute distribution to the predicted attribute distribution comprises calculating an error between a property of the post-shift attribute distribution and the same property of the predicted attribute distribution, and shifting the post-shift attribute distribution is based on the error.

13. The method of claim 11, comprising developing an updated control relationship between the at least one process setting and the attribute.

14. The method of claim 13, wherein developing the updated control relationship comprises conducting a design of experiments process or a calibration.

15. The method of claim 2, wherein adjusting the at least one process setting comprises:
determining one or more causes of deviations of the attribute distribution outside of the specification range; and
modifying an adjustment to the setpoint of the at least one process setting depending on the one or more causes of the deviation of the attribute distribution.

16-22. (canceled)

23. The method of claim 1, wherein the developing the attribute distribution comprises measuring the attribute over a lookback window.

24. The method of claim 23, wherein the lookback window comprises a statistically relevant number of glass articles produced.

25-28. (canceled)

29. The method of claim 1, wherein the attribute distribution deviates from a normal distribution or is a non-symmetric distribution.

30. A system for producing glass articles from a glass tube, the system comprising:
a converter comprising a plurality of processing stations and at least one control device, wherein:
the converter is operable to translate the glass tube through each of the processing stations in sequence;
translating the glass tube through each of the processing stations in sequence forms one or more features of the glass articles and separates the glass articles from a working end of the glass tube;
the glass articles comprise an attribute; and
the at least one control device is operable to change a process setting that effects the attribute of the glass articles;
a measurement device positioned to measure the attribute of the glass articles during or after converting; and
a control system communicatively coupled to the converter and to the measurement device, the control system comprising a processor, a memory module communicatively coupled to the processor, and machine readable and executable instructions stored on the memory module, wherein the machine readable and executable instructions, when executed by the processor, cause the control system to automatically:
measure the attribute of the glass articles with the measurement device;
develop an attribute distribution based on measured values of the attribute of the glass articles;
determine whether a shift in the attribute distribution within a specification range for the attribute increases a yield of the glass articles; and
when the shift in the attribute distribution increases the yield of the glass articles, shift the attribute distribution within the specification range for the attribute.

31. The system of claim 30, wherein the measurement device is positioned in a processing station of the converter, coupled to one or more holders of the converter, positioned downstream of the converter, or combinations of these.

32. The system of claim 30, wherein the system comprising an annealing process for annealing the glass articles and the measurement device is positioned downstream of the annealing process.

33. The system of claim 30, wherein:
the plurality of processing stations comprise a tube length drop station comprising a mechanical stopper and a stopper actuator;
the stopper actuator is configured to change a position of the mechanical stopper axially relative to a working end of the glass tubes; and
the attribute is an overall height of the glass article.

34. The system of claim 30, wherein:
the glass articles are glass vials;
the plurality of processing stations comprises at least one flange forming station comprising one or more forming tools and one or more forming tool actuators operable to change a position of one or more forming tools; and
the attribute is a flange inner diameter of the glass vials.

35. The system of claim 30, wherein the machine readable and executable instructions, when executed by the processor, cause the control system to automatically adjust at least one process setting of the converter to shift the attribute distribution within the specification range for the attribute.

36. The system of claim 35, wherein the machine readable and executable instructions, when executed by the processor, cause the control system to automatically:
determine an updated setpoint of the at least one process setting when the shift in the attribute distribution increases the yield of the glass articles; and
adjust the at least one process setting to the updated setpoint.

37. The system of claim 36, wherein the machine readable and executable instructions, when executed by the processor, cause the control system to automatically calculate the updated setpoint of the at least one process setting from a magnitude and a direction of the shift in the attribute distribution and a control relationship between the at least one process setting and the attribute.

38. The system of claim 37, wherein the machine readable and executable instructions, when executed by the processor, cause the control system to automatically:
conduct a plurality of simulations, wherein in each of the plurality of simulations, the attribute distribution is shifted by a different magnitude, direction, or both;
determine a best simulation from the plurality of simulations, wherein the best simulation produces a greatest yield of the glass articles; and
set the magnitude and the direction of the shift in the attribute distribution equal to the magnitude and the direction corresponding to the best simulation.
